(19) United States
(12) Patent Application Publication
(10) Pub. No.: US 2020/0216355 A1
(43) Pub. Date: Jul. 9, 2020

(54) GLASS FIBER SURFACES WHICH ARE MODIFIED WITHOUT SIZING MATERIAL AND SILANE, COMPOSITE MATERIALS PRODUCED THEREFROM, AND METHOD FOR PRODUCING THE MODIFIED GLASS FIBER SURFACES

(71) Applicant: LEIBNIZ-INSTITUT FUER POLYMERFORSCHUNG DRESDEN E.V., Dresden (DE)

(72) Inventor: Dieter LEHMANN, Dresden (DE)

(73) Assignee: LEIBNIZ-INSTITUT FUER POLYMERFORSCHUNG DRESDEN E.V., Dresden (DE)

(21) Appl. No.: 16/622,486

(22) PCT Filed: Jun. 14, 2018
(86) PCT No.: PCT/EP2018/065805

§ 371 Date: Mar. 23, 2020

(30) Foreign Application Priority Data
Jun. 15, 2017 (DE) 10 2017 113 206.6

(51) Int. Cl. C03C 25/285; C03C 25/321; C03C 25/328; C03C 25/66

(52) U.S. Cl. CPC C03C 25/285; C03C 25/321; C03C 13/003; C03C 25/66; C03C 2213/00; C03C 25/328

(57) ABSTRACT

The invention pertains to the fields of chemistry and mechanical engineering and relates to glass fiber surfaces which are modified without sizing material and silane, which glass fiber surfaces can be further processed into and used as composite materials, for example as reinforcing fiber materials for plastics, and to a method for producing the modified glass fiber surfaces. The object of the present invention is to provide glass fiber surfaces modified without sizing materials and silane, which glass fiber surfaces exhibit improved properties overall and for a further processing into composite materials, and furthermore to provide a simple and cost-effective method for producing glass fiber surfaces modified in such a manner. The object is attained with glass fiber surfaces modified without sizing material and silane, which glass fiber surfaces are at least partially covered at least with a hydrolysis-stable and/or solvolysis-stable cationic polyelectrolyte and/or hydrolysis-stable and/or solvolysis-stable cationic polyelectrolyte mixture and/or with a hydrolysis-stable and/or solvolysis-stable polyelectrolyte complex and coupled to the glass fiber surface via a (polyelectrolyte) complex formation process by means of ionic bonding, with the polyelectrolyte complex A thereby being formed.

The invention pertains to the fields of chemistry and mechanical engineering and relates to glass fiber surfaces which are modified without sizing material and silane, which glass fiber surfaces can be further processed into and used as composite materials, for example as reinforcing fiber materials for plastics, or which can be used in lightweight components, and to a method for producing the modified glass fiber surfaces.

Owing to the mechanical properties and the price/performance ratio, glass fibers are used on a wide scale as reinforcing materials in thermosetting materials/plastics, thermoplastic materials/thermoplastics, and elastomer materials/plastics.

Glass fibers used as commercial reinforcing materials are produced from the melt and further processed into numerous products.

For the various applications, glass fibers are usually processed into roving, nonwoven fiber, mats or fabric. By contrast, oriented fibers are used for profile production.

Known is the use of notch-sensitive glass fibers in a sized manner, whereby a sufficient further processing, mainly in a textile operation, is achieved without the fibers breaking. The development of sizing materials primarily took place in the 1960s through the 1980s. The sizing materials are, virtually without exception, composed of mixtures in which starch and/or polymers, such as polyurethane derivatives and/or epoxy resins and/or silanes and/or waxes et cetera for example, are used and are processed as a dispersion composed of different substances. “In the case of thermoplastics, such as polyamide for example, polyester and epoxy resin sizing materials are typically used; polyurethane sizing materials are common for thermosetting plastics.” [Wikipedia: German-language article for “Schlichte (Fertigungstechnik)” or “Sizing Material (Manufacturing Technique)”].

In polymer-based sizing material compositions (sizing material formulations), additional auxiliary materials such as antistatic agents, lubricants and bonding agents, such as silanes, are also used. For the sake of technological simplification, the sizing material formulations are produced as a multi- or poly-component mixture in the form of an aqueous dispersion in the one-pot processing system and are processed in this manner.

The use of the sizing material on glass fibers typically takes place in the production process for the glass fibers, which are wetted with sizing material via an immersion roller, with the individual filaments then usually being bundled into rovings.

It is known that, with the sizing material, an improved textile workability of the glass fibers and, in addition to the improved workability, also an improvement in the matrix/glass fiber interaction are achieved, whereby the reinforcing effect of sized glass fibers is increased compared to unsized glass fibers. As a result of this improved interaction of matrix molecules via adsorbed and/or coupled sizing material components, acting forces are more effectively diverted or transferred to the glass fibers, which positively affects the reinforcing properties. Furthermore, through the application of sizing material, a certain cohesion of the glass fiber filaments in the roving is achieved. The respective sizing material composition is tailored such that an optimal composite bond of the structural elements into which the roving is worked is achieved. Current sizing material formulations are usually “black box systems,” which means that there is only little or no information about the specific components and the specific amounts thereof in the composition.

Similarly, hardly any publications are known from which information about the type and magnitude of the distribution of sizing material on a glass fiber or a glass fiber bundle can be obtained.

According to Thomason and Dwight [Composites Part A: Applied Science and Manufacturing 30 (1999), 1401-1413] and Gao et al. [Journal of Non-Crystalline Solids 325 (2003), 230-241], it is known that there is a merely irregular distribution of the sizing material on the glass fiber surface. Accordingly, there is no consistent coating of the glass fiber surface with the sizing material.

Using SEM analyses on sized glass fiber materials that were produced in the Leibniz-Institut für Polymerforschung Dresden e.V., it was possible to determine that the sizing material does not form a closed film on the glass fiber or the glass fiber bundle, but rather that the sizing material components from the dispersion are usually only present such that they are adsorbed locally, that is, distributed at points, on the glass fiber surface during the glass fiber production (FIG. 1—glass fiber bundle and FIG. 2—individual glass fiber). Most of the glass fiber surface is present in an unmodified state as free/“naked” glass fiber.

Clearly, this distribution of the sizing material on the glass fiber surface appears to be sufficient for the thus far desired improvements to the properties of glass fibers or glass fiber bundles in plastic compounds.

According to DE 19 23 061 A1, a lubricant or greasing agent for fibers and threads is known for use in the production, treatment and processing of synthetic fiber strands as well as those made of glass. The object of the invention is, in particular, the creation of new and improved lubricants and greasing agents for fibers and threads, which lubricants and agents impart excellent lubricity or sliding properties to the fibers and threads and thereby prevent damage or destruction of the strands or bundles by external or internal abrasive forces normally encountered during processing operations. Furthermore, new and improved lubricants for glass fibers are to be provided which can be incorporated into conventional glass fiber treatment agents, such as sizing compounds. To attain the object, a partially amidated polyalkylene imine with a residual amine value of approximately 200 to 800 is provided which is formed by reacting a polyalkylene imine having a molecular weight of at least approximately 800 with a fatty acid. These sized glass fibers exhibit an excellent lubricity or sliding capacity with a minimum of wear or broken ends. According to one advantageous embodiment, a sizing material composition for application to glass fibers during the production thereof is known, which composition contains a sizing agent and a glass fiber lubricant and greasing agent which comprises a partially amidated polyalkylene imine with a residual amount of amine groups from 200 to 800 which is formed by reacting a polyalkylene imine having a molecular weight of at least approx. 800 with a fatty acid. The partial amidation of the polyalkylene imine with fatty acids is intended to increase the sliding capacity, but decreases the cationic effect of the polyalkylene imine for steric reasons and in terms of charge.

Information about the stability of the sizing material composition composed of a sizing agent and glass fiber lubricant and greasing agent, and also regarding the attachment of these lubricants or greasing agents in this mixture on the glass fiber surface, is not present.

According to DE 23 15 242 A1, polyazamides modified with organosilicon, the production and use of which polyazamides is known, comprise a secondary and/or tertiary amino group and a carboxamide group in the backbone thereof and are bonded through a polyvalent organic group to a silicon atom. The polyazamides, which are polar and hygroscopic, are produced via a Michael addition reaction or haloalkylation. The examination of the adhesive strength of these silicon-containing polyazamides was carried out (Example 54). The glass plates that were surface-treated with these polyazamides that are modified with organosilicon showed excellent adhesion between the glass surface and the cured epoxy resin. Glass plates treated both with polyethyleneimine and also with unmodified polyazamide showed no adhesion after an analogous water treatment.

Thus, with this Example 54, it is stated that the glass surfaces, and by extension glass fibers, which were treated with polyethyleneimine and unmodified polyazamide and subsequently reacted with epoxy resin do not form a (hydrolysis-) stable compound in water.

DE 24 47 311 discloses a surface sizing agent and a use thereof for coating glass fibers. There, coatings on fibers are described which are texturized, wherein a cationized starch in a mixture with other sizing material components is used as a sizing agent for glass fibers. It was furthermore discovered that cationic starch materials in particular change viscosity with a change in pH, and that known cationic starch materials lose their dispersant power as the pH approaches or exceeds 7. It was also discovered that known cationic lubricants employ quaternary primary amines, and that quaternary amines cannot be used since they agglomerate when they are exposed to the fibers in a thin layer.

According to DE 692 10 056 T2, a starch-oil treatment for glass fibers for textile applications is known, in which treatment an aqueous, starch-containing poly-component sizing material composition for treating glass fibers is used, in which starch-oil sizing material composition an imine alkyl alkoxy silane coupling agent that is a reaction product of an imine compound selected from the group comprising ethyleneimine and polyethyleneimine and of an amino alkyl alkoxy silane selected from the group comprising monoaminoalkyl alkoxy silane and diamino alkyl alkoxy silane is contained in an amount equal to 0.1 wt % to 3.0 wt % of the non-aqueous components.

In summary, the ordinarily skilled artisan can assume that unmodified cationic polyelectrolytes, such as polyethyleneimine or polyazamides, are poorly suited or unsuitable for treating glass fiber and for subsequent (further) processing, since only modified cationic polyelectrolytes, usually as a component of sizing material mixtures, have been used up to now. Furthermore, it can also be assumed that the use of poly-component sizing material formulations is often problematic under processing conditions.

In addition, polyelectrolytes are generally known as methods and processes which result in a polyelectrolyte adsorption (Wikipedia, German-language keyword “Polyelektrolyte”). Accordingly, “dissolved polyelectrolytes can be adsorbed onto oppositely charged surfaces. The adsorption is driven, among other things, by the electrostatic attraction between the charged monomer units and oppositely charged, dissociated surface groups (e.g., SiO⁻ groups on silicon dioxide surfaces). However, the release of counterions or the formation of hydrogen bonds also enable adsorption. The conformation of the polyelectrolyte in a dissolved state determines the amount of substance adsorbed. Extended polyelectrolyte molecules adsorb onto the surface as thin films (0.2 nm-1 nm), whereas coiled polyelectrolyte molecules form thicker layers (1 nm-8 nm).”

A disadvantage of the known solutions is that the surface modification of glass fibers with sizing materials or silanes in most cases has not yet been developed well enough for a suitable capacity for further processing by chemical reaction(s). Even more inadequate are the properties of the surfaces of glass fibers when they are to be further processed without sizing materials or silanes.

The object of the present invention is to provide glass fiber surfaces modified without sizing materials and silane, which glass fiber surfaces exhibit improved properties overall and for a further processing into composite materials, and furthermore to provide a simple and cost-effective method for producing glass fiber surfaces modified in such a manner.

The object is attained with the invention disclosed in the patent claims, wherein combinations of the individual dependent patent claims are also included within the meaning of a logical AND operation, provided that they are not mutually exclusive.

The glass fiber surfaces modified without sizing material and silane are at least partially covered at least with a hydrolysis-stable and/or solvolysis-stable cationic polyelectrolyte and/or a hydrolysis-stable and/or solvolysis-stable cationic polyelectrolyte mixture and/or a hydrolysis-stable and/or solvolysis-stable polyelectrolyte complex and coupled to the glass fiber surface via a (polyelectrolyte) complex formation process by means of ionic bonding, thereby forming the polyelectrolyte complex A.

Advantageously, a hydrolysis-stable and/or solvolysis-stable polyelectrolyte complex A is present which has been created
by a (polyelectrolyte) complex formation of the glass fiber surface with hydrolysis-stable and/or solvolysis-stable cationic polyelectrolytes; and/or
by a (polyelectrolyte) complex formation of the glass fiber surface with hydrolysis-stable and/or solvolysis-stable cationic polyelectrolyte mixtures; and/or
by a (polyelectrolyte) complex formation of the glass fiber surface with hydrolysis-stable and/or solvolysis-stable polyelectrolyte complexes having an excess of cationic charges, which polyelectrolyte complexes have been produced before being applied to the glass fiber surface.

Likewise advantageously, the hydrolysis-stable and/or solvolysis-stable polyelectrolyte complex A covers the glass fiber surface completely or essentially completely.

Also advantageously, the following are present as a hydrolysis-stable and/or solvolysis-stable cationic polyelectrolyte or hydrolysis-stable and/or solvolysis-stable cationic polyelectrolyte mixture:
poly(diallyldimethylammonium chloride) (polyDADMAC) and/or copolymers; and/or
polyallylamine and/or copolymers; and/or
polyvinylamine and/or copolymers; and/or
polyvinylpyridine and/or copolymers; and/or
polyethyleneimine (linear and/or branched) and/or copolymers; and/or
chitosan; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s); and/or
cationic starch derivatives and/or cellulose derivatives.

And also advantageously, the following are present as functionalities on the hydrolysis-stable and/or solvolysis-stable cationic polyelectrolyte or hydrolysis-stable and/or solvolysis-stable cationic polyelectrolyte mixture:
unmodified primary and/or secondary and/or tertiary amino groups that do not have substituents on the amine nitrogen atom with an additional reactive and/or activatable functional group and/or olefinically unsaturated double bond, and/or quaternary ammonium groups which do not have substituents on the nitrogen atom with an additional reactive and/or activatable functional group and/or olefinically unsaturated double bond, and/or
have amino groups and/or quaternary ammonium groups which are at least partially chemically modified on the nitrogen atom via alkylation reactions, with at least one additional reactive and/or activatable functional group and/or at least one olefinically unsaturated double bond,

and/or
have amino groups and/or quaternary ammonium groups and amide groups which are chemically modified via acylation reactions of amino groups to amide, with at least one additional reactive and/or activatable functional group and/or at least one olefinically unsaturated double bond.

It is also advantageous if at least one anionic polyelectrolyte or one anionic polyelectrolyte mixture without and/or with at least one additional reactive and/or activatable functional group different from the anionic group and/or with at least one olefinically unsaturated double bond are present as functionalities on the hydrolysis-stable and/or solvolysis-stable cationic polyelectrolyte or hydrolysis-stable and/or solvolysis-stable cationic polyelectrolyte mixture attached to the glass fiber surface.

It is furthermore advantageous if the following are present as anionic polyelectrolyte or anionic polyelectrolyte mixture:

(a) (meth)acrylic acid copolymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylic acid group, and which are preferably water-soluble, and/or

(b) modified maleic acid (anhydride) copolymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of maleic acid (anhydride) groups, and which are preferably water-soluble, and/or

(c) modified itaconic acid (anhydride) (co)polymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of itaconic acid (anhydride) groups, and which are preferably water-soluble, and/or

(d) modified fumaric acid copolymers which are preferably present in the acid and/or monoester and/or monoamide form, and/or which are present without and/or with at least one additional reactive and/or activatable functional group that was introduced via the copolymerization, and or which are present with at least one additional reactive and/or activatable functional group and/or at least one olefinically unsaturated double bond that are coupled via a polymer-analogous reaction/modification of fumaric acid groups, and which are preferably water-soluble, and/or

(e) anionically modified (meth)acrylamide (co)polymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylamide group, and which are preferably water-soluble, and/or

(f) sulfonic acid (co)polymers, such as for example styrenesulfonic acid (co)polymers and/or vinylsulfonic acid (co)polymers in acid and/or salt form, which are present with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of sulfonic acid groups, such as via sulfonic acid amide groups for example, and which are preferably water-soluble, and/or

(g) (co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive and/or activatable functional group that was introduced via the copolymerization, and/or which are present with at least one additional reactive and/or activatable functional group and/or with at least one olefinically unsaturated double bond that are coupled via a polymer-analogous (co)polymer reaction/modification, and which are preferably water-soluble.

It is likewise advantageous if the hydrolysis-stable and/or solvolysis-stable cationic polyelectrolytes or the hydrolysis-stable and/or solvolysis-stable cationic polyelectrolyte mixture has a molecular weight under 50,000 dalton, preferably in the range between 400 and 10,000 dalton.

In the composite materials according to the invention with glass fibers having glass fiber surfaces modified without sizing material and silane, in which composite materials hydrolysis-stable and/or solvolysis-stable polyelectrolyte complexes A and/or B which are present in an at least partially covering manner on glass fiber surfaces without sizing material and silane and which comprise functional groups and/or olefinically unsaturated double bonds, are present such that they are coupled via a chemically covalent bond to additional materials after a reaction with functional groups and/or olefinically unsaturated double bonds.

At least one at least difunctional and/or difunctionalized low-molecular-weight and/or oligomeric and/or polymeric agent with functional groups and/or olefinically unsaturated double bonds are advantageously present as additional materials.

Likewise advantageously, thermoplastics and/or thermosets and/or elastomers are present as additional materials as matrix materials for glass fibers.

Also advantageously, amino groups, preferably primary and/or secondary amino groups, and/or quaternary ammonium groups are present as functionalities of the adsorbed hydrolysis-stable and/or solvolysis-stable cationic polyelectrolyte complex.

In the method according to the invention for producing glass fiber surfaces modified without sizing material and silane, a hydrolysis-stable and/or solvolysis-stable cationic polyelectrolyte and/or a hydrolysis-stable and/or solvolysis-stable cationic polyelectrolyte mixture and/or a hydrolysis-stable and/or solvolysis-stable polyelectrolyte complex having an excess of cationic charges are applied from an aqueous solution at a concentration of maximally 5 wt % to the glass fiber surfaces in an at least partially covering manner during or after the production of glass fibers, wherein hydrolysis-stable and/or solvolysis-stable cationic polyelectrolytes and/or hydrolysis-stable and/or solvolysis-stable cationic polyelectrolyte mixtures with a molecular weight under 50,000 dalton and/or a hydrolysis-stable and/or solvolysis-stable polyelectrolyte complex with an excess of cationic charges are used.

Polyelectrolytes which are not subsequently alkylated and/or acylated and/or sulfamidated after production are advantageously used as hydrolysis-stable and/or solvolysis-stable cationic polyelectrolytes, or polyelectrolyte mixtures that are not subsequently alkylated and/or acylated and/or sulfamidated after production are advantageously used as hydrolysis-stable and/or solvolysis-stable cationic polyelectrolyte mixtures.

The following are also advantageously used as hydrolysis-stable and/or solvolysis-stable unmodified cationic polyelectrolyte, as a pure substance or substances or in a mixture, preferably dissolved in water:
poly(diallyldimethylammonium chloride) (polyDADMAC) and/or copolymers;
and/or
polyallylamine and/or copolymers; and/or
polyvinylamine and/or copolymers; and/or
polyvinylpyridine and/or copolymers; and/or
polyethyleneimine (linear and/or branched) and/or copolymers; and/or
chitosan; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and, for example, (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and, for example, (N,N-dialkylaminoalkylene)amine(s); and/or
cationic starch derivatives and/or cellulose derivatives.

Likewise advantageously, hydrolysis-stable and/or solvolysis-stable cationic poly electrolytes and/or hydrolysis-stable and/or solvolysis-stable cationic polyelectrolyte mixtures and/or hydrolysis-stable and/or solvolysis-stable polyelectrolyte complexes with an excess of cationic charges are used at a concentration of maximally 5 wt % in water or in water with the addition of acid, such as carboxylic acid, for example formic acid and/or acetic acid, and/or mineral acid, without additional sizing material or sizing material components and/or silanes.

And also advantageously, hydrolysis-stable and/or solvolysis-stable cationic poly electrolytes which are not subsequently alkylated and/or acylated and/or sulfamidated after production and/or hydrolysis-stable and/or solvolysis-stable cationic polyelectrolyte mixtures that are not subsequently alkylated and/or acylated and/or sulfamidated after production are used at a concentration of <2 wt %, and particularly preferably at <0.8 wt %.

It is also advantageous if hydrolysis-stable and/or solvolysis-stable cationic polyelectrolytes and/or hydrolysis-stable and/or solvolysis-stable cationic polyelectrolyte mixtures with a molecular weight under 50,000 dalton, preferably in the range between 400 dalton and 10,000 dalton, are used.

It is likewise advantageous if a modified hydrolysis-stable and/or solvolysis-stable cationic polyelectrolyte and/or a hydrolysis-stable and/or solvolysis-stable cationic polyelectrolyte mixture that is partially alkylated and/or acylated and/or reacted with carboxylic acid derivatives and/or sulfamidated in a subsequent reaction following production, and is thus equipped with a substituent having reactive and/or activatable groups for a coupling reaction, is then, having the reactive and/or activatable groups of the covalently coupled substituent, reacted with additional materials to form a composite material via at least one functional group and/or via at least one olefinically unsaturated double bond without crosslinking of the hydrolysis-stable and/or solvolysis-stable cationic polyelectrolyte or of the hydrolysis-stable and/or solvolysis-stable cationic polyelectrolyte mixture.

It is furthermore advantageous if the partial alkylation of the hydrolysis-stable and/or solvolysis-stable cationic polyelectrolyte or of the hydrolysis-stable and/or solvolysis-stable cationic polyelectrolyte mixture, with substituents having reactive groups thereby being introduced, is achieved through haloalkyl derivatives and/or (epi)halohydrin compounds and/or epoxy compounds and/or compounds which enter into a Michael-analogous addition, advantageously such as acrylates and/or acrylonitrile with amines.

And it is also advantageous if the partial acylation of the hydrolysis-stable and/or solvolysis-stable cationic polyelectrolyte or of the hydrolysis-stable and/or solvolysis-stable cationic polyelectrolyte mixture, with substituents having reactive groups thereby being introduced, is achieved through carboxylic acids and/or carboxylic acid halides and/or carboxylic acid anhydrides and/or carboxylic acid esters and/or diketenes, or if a quasi-acylation is achieved through isocyanates and/or urethanes and/or carbodiimides and/or uretdiones and/or allophanates and/or biurets and/or carbonates.

It is also advantageous if the hydrolysis-stable and/or solvolysis-stable cationic polyelectrolytes and/or the hydrolysis-stable and/or solvolysis-stable cationic polyelectrolyte mixture and/or the hydrolysis-stable and/or solvolysis-stable polyelectrolyte complexes with an excess of cationic charges are used such that they are dissolved in water, preferably as an ammonium compound, wherein in the case of primary and/or secondary and/or tertiary amino groups carboxylic acid(s) and/or mineral acid(s) are added to the aqueous solution to convert the amino groups into the ammonium form.

It is likewise advantageous if modified glass fiber surfaces that are at least partially, and preferably completely, covered at least with a hydrolysis-stable and/or solvolysis-stable cationic polyelectrolyte or a hydrolysis-stable and/or solvolysis-stable cationic polyelectrolyte mixture and/or a hydrolysis-stable and/or solvolysis-stable polyelectrolyte complex with an excess of cationic or anionic charges are, directly following the production and coating/surface modification thereof and/or at a later point, reacted with additional materials, with chemically covalent bonds thereby being formed.

It is furthermore advantageous if the modified glass fiber surfaces are wound and/or intermediately stored as roving and are subsequently reacted with additional materials, with chemically covalent bonds thereby being formed.

And it is also advantageous if the hydrolysis-stable and/or solvolysis-stable cationic polyelectrolyte or the hydrolysis-stable and/or solvolysis-stable cationic polyelectrolyte mixture and/or the hydrolysis-stable and/or solvolysis-stable polyelectrolyte complex with an excess of cationic or anionic charges comprises reactive groups in the form of functional groups and/or olefinically unsaturated double bonds that are reacted with functionalities of the additional materials, with chemically covalent bonds thereby being formed.

And lastly, it is also advantageous if an aqueous solution with a concentration of maximally 5 wt % of a hydrolysis-stable and/or solvolysis-stable cationic polyelectrolyte and/or of a hydrolysis-stable and/or solvolysis-stable cationic polyelectrolyte mixture and/or of a hydrolysis-stable and/or solvolysis-stable polyelectrolyte complex with an excess of cationic charges is applied in an at least partially covering manner to commercially produced and sized glass fiber surfaces, or to glass fiber surfaces without sizing material and silane, wherein cationic polyelectrolytes or cationic polyelectrolyte mixtures with a molecular weight under 50,000 dalton are used.

With the solution according to the invention, it is for the first time possible to provide glass fiber surfaces modified without sizing material and silane, which glass fiber surfaces exhibit improved properties overall and for a further processing into composite materials.

Likewise, it is for the first time possible to provide a simple and cost-effective method for producing glass fiber surfaces modified in such a manner.

This is achieved with glass fiber surfaces modified without sizing material and silane, which glass fiber surfaces are at least partially covered at least with a hydrolysis-stable and/or solvolysis-stable cationic polyelectrolyte or polyelectrolyte mixture and/or a hydrolysis-stable and/or solvolysis-stable polyelectrolyte complex and coupled to the glass fiber surface via a (polyelectrolyte) complex formation process by means of ionic bonding.

According to the invention, a hydrolysis-stable and/or solvolysis-stable cationic polyelectrolyte is to be understood as meaning all polyelectrolytes that are hydrolysis-stable and/or solvolysis-stable and have cationic charges and are colloquially also referred to as a polycation.

According to the invention, a hydrolysis-stable and/or solvolysis-stable cationic polyelectrolyte mixture is to be understood as meaning all mixtures of at least two or more polyelectrolytes that are hydrolysis-stable and/or solvolysis-stable and have cationic charges and are colloquially also referred to as a polycation mixture.

Such hydrolysis-stable and/or solvolysis-stable cationic polyelectrolytes or hydrolysis-stable and/or solvolysis-stable cationic polyelectrolyte mixtures can advantageously be present as
poly(diallyldimethylammonium chloride) (polyDADMAC) and/or copolymers; and/or
polyallylamine and/or copolymers; and/or
polyvinylamine and/or copolymers; and/or
polyvinylpyridine and/or copolymers; and/or
polyethyleneimine (linear and/or branched) and/or copolymers; and/or
chitosan; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s); and/or
cationic starch derivatives and/or cellulose derivatives.

A hydrolysis-stable and/or solvolysis-stable polyelectrolyte complex A according to the invention is to be understood according to the invention as meaning a polyelectrolyte complex which has been created:
by a (polyelectrolyte) complex formation of the glass fiber surface with hydrolysis-stable and/or solvolysis-stable cationic polyelectrolytes; and/or
by a (polyelectrolyte) complex formation of the glass fiber surface with hydrolysis-stable and/or solvolysis-stable cationic polyelectrolyte mixtures; and/or
by a complex formation of the glass fiber surface with hydrolysis-stable and/or solvolysis-stable polyelectrolyte complexes having an excess of cationic charges, which polyelectrolyte complexes have been produced before being applied to the glass fiber surface.

All of these polyelectrolyte complexes according to the invention are created during or after production of the modified glass fiber surface via a complex formation process from the anionically charged glass fiber surface and the hydrolysis-stable and/or solvolysis-stable cationic polyelectrolyte and/or polyelectrolyte mixture and/or polyelectrolyte complex having an excess of cationic charges, which polyelectrolyte and/or polyelectrolyte mixture and/or polyelectrolyte complex is applied to the glass fiber surface, and are hereinafter also referred to as polyelectrolyte complex A. Thus, according to the invention, the polyelectrolyte complex A is always formed with the glass fiber surface.

Furthermore, the hydrolysis-stable and/or solvolysis-stable polyelectrolyte complex according to the invention can also be a hydrolysis-stable and/or solvolysis-stable polyelectrolyte complex which is composed of the polyelectrolyte complex A and of at least one hydrolysis-stable and/or solvolysis-stable anionic polyelectrolyte applied to the polyelectrolyte complex A in a subsequent step or a hydrolysis-stable and/or solvolysis-stable anionic polyelectrolyte mixture that has been formed via an attachment to and a (polyelectrolyte) complex formation with the polyelectrolyte complex A. A hydrolysis-stable and/or solvolysis-stable anionic polyelectrolyte applied to the polyelectrolyte complex A or a hydrolysis-stable and/or solvolysis-stable anionic polyelectrolyte mixture and polyelectrolyte complex created via a (polyelectrolyte) complex formation process is hereinafter referred to as polyelectrolyte complex B.

Advantageously, the hydrolysis-stable and/or solvolysis-stable polyelectrolyte complex B can for process-related reasons have cationic and/or anionic charges at the surface via setting of the concentration of hydrolysis-stable and/or solvolysis-stable anionic polyelectrolyte or hydrolysis-stable and/or solvolysis-stable anionic polyelectrolyte mixture, that is, depending on the structure and composition, wherein an excess of anionic charge is advantageously present.

Additional polyelectrolyte complexes C can be coupled to the polyelectrolyte complex B in a subsequent step using known methods, in that an additional hydrolysis-stable and/or solvolysis-stable cationic polyelectrolyte or a hydrolysis-stable and/or solvolysis-stable cationic polyelectrolyte mixture can be attached to the polyelectrolyte complex B with an excess of anionic charges at the surface, likewise via a (polyelectrolyte) complex formation process, and a layer structure of (different) polyelectrolyte complexes is then subsequently produced on the glass fiber surface in an alternating manner from anionic and cationic polyelectrolytes or from anionic and cationic polyelectrolyte mixtures.

If the surface-modified glass fiber with the polyelectrolyte complex B only has residual cationic charges still coming from the polyelectrolyte complex A due to partial coverage, cationic polyelectrolyte or a cationic polyelectrolyte mixture can be attached to the regions of the polyelectrolyte complex B that are coated with anionic polyelectrolyte (mixture), and anionic and cationic polyelectrolytes or cationic polyelectrolyte mixtures can subsequently be attached with the layer structure being alternated.

Additional polyelectrolyte complexes can be coupled to the polyelectrolyte complex B as C, D, E, etc., in subsequent steps using known methods, in that an additional hydrolysis-stable and/or solvolysis-stable cationic polyelectrolyte or a hydrolysis-stable and/or solvolysis-stable cationic polyelectrolyte mixture can be attached to the polyelectrolyte complex B with an excess of anionic charges at the surface, likewise via a (polyelectrolyte) complex formation process, and a layer structure of (different) polyelectrolyte complexes is subsequently produced on the glass fiber surface in an alternating manner from cationic and anionic polyelectrolytes or from cationic and anionic polyelectrolyte mixtures.

The hydrolysis-stable and/or solvolysis-stable cationic and/or anionic polyelectrolytes or polyelectrolyte mixtures and/or hydrolysis-stable and/or solvolysis-stable polyelectrolyte complexes present according to the invention should thereby be stable, both before the application to the glass fiber surface and also afterwards, in particular under the respectively necessary processing conditions.

The glass fiber surfaces modified without sizing material and silane have a high and preferably full degree of coverage with at least the polyelectrolyte complex A and/or advantageously also with a polyelectrolyte complex B after a further modification.

According to the invention, the at least partial coverage is to be understood as meaning a degree of coverage of at least more than 50% of the glass fiber surface and/or the glass fiber bundle surface, wherein according to the invention an at least 80% and preferably a 100% coverage is to be achieved, and also is achieved.

The glass fiber surfaces modified without sizing material and silane according to the invention can be further modified in an unchanged state, or after one or more additional chemical modification reactions with one or more reagents via addition and/or substitution reactions in one or more subsequent steps, or in an in situ reaction during the processing as reinforcing material.

The glass fiber surfaces modified without sizing material and silane according to the invention form a strong hydrolysis-stable and/or solvolysis-stable strong material bond that cannot be achieved via the attachment of sizing material or silane-containing sizing material to the glass fiber surface according to the prior art.

With the present invention, glass fiber surfaces modified without sizing material and silane are present, wherein glass fibers having the surfaces modified according to the invention can be used as reinforcing material for thermoplastics, elastomers or thermosets.

Modified glass fiber surfaces of this type can then be reacted with an additional material to form a composite material, whereby functionalities of the polyelectrolyte complex A or B enter into a chemically covalent bond with functionalities of the additional materials.

A chemically covalent bond of this type can, in addition to a complex formation of the cationic polyelectrolyte or polyelectrolyte mixture with additional anionic materials having reactive functional groups (such as epoxy groups and/or anhydride groups), also take place in a reaction with amino groups.

The following can be advantageously present as functionalities on the hydrolysis-stable and/or solvolysis-stable cationic polyelectrolyte or hydrolysis-stable and/or solvolysis-stable cationic polyelectrolyte mixture:
unmodified primary and/or secondary and/or tertiary amino groups that do not have substituents on the amine nitrogen atom with an additional reactive and/or activatable functional group and/or olefinically unsaturated double bond, and/or quaternary ammonium groups which do not have substituents on the nitrogen atom with an additional reactive and/or activatable functional group and/or olefinically unsaturated double bond, and/or
amino groups and/or quaternary ammonium groups which are at least partially chemically modified on the nitrogen atom via alkylation reactions, with at least one additional reactive and/or activatable functional group and/or at least one olefinically unsaturated double bond, and/or
amino groups and/or quaternary ammonium groups and amide groups which are chemically modified via acylation reactions of amino groups to amide, with at least one additional reactive and/or activatable functional group and/or at least one olefinically unsaturated double bond.

Likewise, at least one anionic polyelectrolyte or one anionic polyelectrolyte mixture without and/or with at least one additional reactive and/or activatable functional group different from the anionic group and/or with at least one olefinically unsaturated double bond can be present as polyelectrolyte complex B, for example, as functionalities on the hydrolysis-stable and/or solvolysis-stable cationic polyelectrolyte or hydrolysis-stable and/or solvolysis-stable cationic polyelectrolyte mixture attached to the glass fiber surface as polyelectrolyte A.

This reaction for the formation of the chemically covalent bond can take place directly or immediately following the glass fiber production process. However, it is also possible to not carry out this formation of the chemically covalent bond(s) until directly during the application case, and even only then for the glass fiber surfaces modified without sizing material and silane and/or the additional materials to be equipped with functionalities which then achieve the chemically covalent bond(s) in the applications case. An approach of this type is easily achieved with the present invention, since the glass fiber surfaces, the modifying agents, and the additional materials can be easily handled and metered and are well-suited to further processing.

Glass fiber surfaces modified without sizing material and silane according to the invention can be further processed with additional materials into composite materials according to the invention. Glass fibers modified in such a manner can be used as reinforcing fiber materials for plastics, for example.

It is particularly advantageous for the present invention that the glass fibers with the surfaces modified according to the invention can be modified during and/or after the glass fiber production with properties tailored to additional materials, for example matrix materials for glass fibers, and can be further processed into short glass fiber-reinforced or long glass fiber-reinforced thermoplastic, thermosetting or elastomer materials.

The textile processing of glass fibers requires suitable sliding characteristics of the glass fiber surface in order to prevent processing problems such as glass fiber breakage. Where glass fibers are produced and used for the reinforcement of plastics, however, sliding characteristics such as those for textile processing are not absolutely necessary. On the contrary, a sufficient workability and a very good interaction between the glass fiber as a reinforcing material and the matrix surrounding the glass fibers is the focal point for achieving the optimal stiffness and the mechanical properties in the corresponding composite material.

For this purpose, sizing materials or sizing material mixtures are mainly used to modify the glass fiber surface in the prior art, which materials or mixtures are composed of a plurality of substances and which contain specific silanes as adhesion promoting substances. The silanes are intended to achieve a chemical bond between the glass fiber and the matrix via a reaction with the glass fiber surface.

The silanes, which in most cases are used as alkoxysilane, are used in an aqueous sizing material dispersion that is not adequately stable for the duration of the application and changes depending on the ambient conditions (such as temperature, pH, concentration, etc., for example). The changes occur via reactions with one another, for example, also with a formation of Si—O—Si bonds; in other words: The silanes condense with one another and possibly also with sizing material (components) and are thus chemically altered as sizing material (component). After application to the glass fiber surface of such sizing material or sizing material mixtures that change(s) over time, which material or mixtures do(es) not form a closed surface film, that is, is/are not present on the glass fiber surface across the entire area, but rather only to a locally limited extent or at points and distributed, these glass fibers are wound into a roving according to the prior art. As a result of the winding, the glass fibers easily become “stuck” to one another in the roving strand, which in many respects is also desirable for further handling. The roving strand is then usually also dried. In direct glass fiber 1/sizing material 1−sizing material 2/glass fiber 2 contact, the local sticking taking place between glass fibers and sizing material components has the effect that, during the unwinding of the glass fibers from the roving and during the further processing into short glass fiber-reinforced or long glass fiber-reinforced materials, a “tearing-away of sizing material components” from the glass fiber surfaces among one another occurs, whereby additional imperfections develop on the glass fiber surfaces.

In SEM images (as FIG. 1 and FIG. 2 also show), primarily the unmodified/“naked” glass fiber surfaces are visible with isolated sizing material points or points with “sizing material blobs.”

Within the scope of the present invention, “materially bonded” is to understood as meaning that the formed polyelectrolyte complex A is present such that it is firmly bonded to the glass fiber surface via a plurality of coupling points of the hydrolysis-stable and/or solvolysis-stable cationic polyelectrolyte or polyelectrolyte mixture and/or of the hydrolysis-stable and/or solvolysis-stable polyelectrolyte complex with an excess of cationic charges, and is not, as in the case of the surface modification of glass fibers with sizing material or sizing material mixture(s) according to the prior art, present in a relatively loosely bonded manner at points as “blobs” merely with a few individual coupling points per sizing material particle or sizing material aggregate. The polyelectrolyte complex A formed in a materially bonded manner cannot be removed by extraction. With sized glass fiber surfaces according to the prior art, however, the sizing material or sizing material components can in large part be separated/removed from the glass fiber surface again by extraction.

With the present invention, coated glass fibers can be provided and produced which comprise at the glass fiber surface a hydrolysis-stable and/or solvolysis-stable polyelectrolyte complex A fixed via ionic bonds, wherein it is advantageous if the polyelectrolyte complex A has an excess of cationic charges, and/or the polyelectrolyte complex A was treated with a hydrolysis-stable and/or solvolysis-stable anionic polyelectrolyte or polyelectrolyte mixture, and a hydrolysis-stable and/or solvolysis-stable polyelectrolyte complex B fixed via ionic bonds is thereafter present, wherein an excess of anionic charges in the polyelectrolyte complex B is advantageous.

The polyelectrolyte complex A coupled according to the invention and advantageously also the polyelectrolyte complex B and/or C are arranged in a materially bonded and at least partially, advantageously covering manner on the glass surface.

With these glass fibers surface-modified without sizing material and silane according to the invention, composite materials can then be produced in which functionalities of the hydrolysis-stable and/or solvolysis-stable polyelectrolyte complex A or B, which functionalities cover the glass fiber surface virtually completely, and preferably in a completely materially bonded manner via ionic bonds through a (polyelectrolyte) complex formation process, are present such that they are coupled with functionalities of additional materials via a chemically covalent bond.

The glass fiber surfaces modified without sizing material and silane according to the invention are produced according to the invention in that, during or after the production of glass fibers, an aqueous solution with a concentration of 5 wt %
of a hydrolysis-stable and/or solvolysis-stable, preferably unmodified, cationic polyelectrolyte and/or
of a hydrolysis-stable and/or solvolysis-stable, preferably unmodified, cationic polyelectrolyte mixture and/or
of a hydrolysis-stable and/or solvolysis-stable polyelectrolyte complex with an excess of cationic charges

is applied to the glass fiber surfaces, preferably in a completely covering manner, wherein hydrolysis-stable and/or solvolysis-stable cationic poly electrolytes and/or hydrolysis-stable and/or solvolysis-stable cationic polyelectrolyte mixtures with a molecular weight under 50,000 dalton and/or a hydrolysis-stable and/or solvolysis-stable polyelectrolyte complex with an excess of cationic charges are used.

Linear and/or branched cationic polyelectrolyte compounds with a molecular weight preferably under 50,000 dalton can be advantageously used thereby.

The composite materials according to the invention with the modified glass fiber surfaces are produced according to the invention in that the glass fiber surfaces at least partially covered at least with the hydrolysis-stable and/or solvolysis-stable cationic polyelectrolyte complex A are reacted with additional materials directly following the production and coating of the glass fiber surfaces and/or at a later point, with chemically covalent bonds thereby being formed.

In the production of the coating on the glass fiber surfaces, hydrolysis-stable and/or solvolysis-stable, preferably unmodified, cationic polyelectrolytes and/or hydrolysis-stable and/or solvolysis-stable, preferably unmodified, cationic polyelectrolyte mixtures and/or hydrolysis-stable and/or solvolysis-stable polyelectrolyte complexes with an excess of cationic charges are used at a concentration of maximally 5 wt %, advantageously at a concentration of <2 wt %, and particularly preferably at a concentration of <0.8 wt %, wherein the concentration is respectively set depending on the type of the hydrolysis-stable and/or solvolysis-stable, preferably unmodified, cationic polyelectrolyte and/or hydrolysis-stable and/or solvolysis-stable, preferably unmodified, cationic polyelectrolyte mixture and/or hydrolysis-stable and/or solvolysis-stable polyelectrolyte complex with an excess of cationic charges, on the charge density in the macromolecule, on the type of cationic group (primary, secondary, tertiary amino group or quaternary ammonium group), on the degree of branching, and on the molecular weight. A setting and optimization of the setting of the concentration in this manner is possible for the ordinarily skilled artisan in a few experiments. Furthermore, the setting of the concentration of hydrolysis-stable and/or solvolysis-stable, preferably unmodified, cationic polyelectrolyte and/or of hydrolysis-stable and/or solvolysis-stable, preferably unmodified, cationic polyelectrolyte mixture and/or of hydrolysis-stable and/or solvolysis-stable polyelectrolyte complex with an excess of cationic charges is also dependent on whether this surface modification is carried out directly during the glass fiber production process and/or afterwards, that is, downstream. The setting of the concentration should be adapted to the respective process, wherein an overcharging within the meaning of polyelectrolyte chemistry as concentrations which are too high should be avoided. An overcharging would be present where the packing or coverage density on the glass fiber surface is too high and the cationic polyelectrolyte molecules are not optimally arranged on the glass fiber surface as a result.

This can be avoided by optimizing the concentration via a few advance trials, or by subsequently storing the modified glass fibers in an aqueous medium in which, depending on the time, the pH, the type of salt or salt mixture added, as well as the salt concentration and temperature, a rearrangement towards an optimal coverage density occurs, with the excessively attached cationic polyelectrolyte macromolecules thereby being (very) slowly released.

The modification of the glass fiber surface with the hydrolysis-stable and/or solvolysis-stable polyelectrolyte complex A takes place in water or in water with a solvent additive and/or acid additive, for example, one or more carboxylic acids such as formic acid and/or acetic acid for example, and/or mineral acids. It is thereby particularly advantageous that the use of sizing material or sizing material components such as silanes can be completely omitted for the production and further processing of the modified glass fiber surfaces according to the invention. However, it is also possible that glass fiber surfaces coated with sizing material according to the prior art can be subsequently modified according to the invention, or that sizing material or sizing material components can also be applied to the modified glass fiber surface.

According to the invention, a glass fiber surface modified without sizing material and silane was discovered which, in contrast to the statement in DE 2 315 242, Example 54, exhibits very good adhesion for the additional materials that can subsequently be applied, and a composite material with very good adhesion can thus be produced and provided.

Within the scope of the present invention, polycations or polycation mixtures or polyelectrolyte complexes with an excess of cationic charges are to be understood and used as unmodified cationic polyelectrolytes, which are used such that, after production, they are modified neither in a subsequent reaction nor chemically modified with low-molecular-weight and/or oligomeric and/or polymeric agents, that is, alkylated (for example, through haloalkyl derivatives and/or (epi)halohydrin compounds and/or epoxy compounds or derivatives) and/or acylated (for example, through agent(s) with one or more carboxylic acid groups and/or carboxylic acid halide groups and/or carboxylic anhydride groups and/or carboxylic acid ester groups and/or diketenes and/or diketene-acetone adduct) and/or reacted with carboxylic acid derivatives, that is, quasi-acylated (for example, through agent(s) with one or more isocyanate groups and/or urethane groups and/or carbodiimide groups and/or uretdione groups and/or allophanate groups and/or biuret groups and/or carbonate groups) and/or sulfamidated. In water, the cationic polyelectrolyte (mixture) is used in a dissolved state, preferably as an ammonium compound; that is, if the amino groups of the cationic polyelectrolyte (mixture) are present as primary and/or secondary and/or tertiary amino groups, they are at least partially converted to the ammonium form via addition of an acid.

For example, the following are used as cationic polyelectrolyte or in a mixture:
poly(diallyldimethylammonium chloride) (polyDADMAC) and/or copolymers
polyallylamine and/or copolymers
polyvinylamine and/or copolymers
polyvinylpyridine and/or copolymers
polyethyleneimine (linear and/or branched) and/or copolymers
chitosan
poly(amide-amine) and/or copolymers
cationically modified poly(meth)acrylate(s) and/or copolymers
cationically modified poly(meth)acrylamide(s) with amino groups and/or ammonium groups, and/or copolymers
cationically modified maleimide copolymer(s), produced from maleic acid (anhydride) copolymer(s) and, for example, (N,N-dialkylaminoalkylene)amine(s), wherein alternating maleic acid (anhydride) copolymers are preferably used
cationically modified itaconic imide (co)polymer(s), produced from itaconic acid (anhydride) (co)polymer(s) and, for example, (N,N-dialkylaminoalkylene)amine(s)
cationic starch derivatives and/or cellulose derivatives

The list recites available/commercial and easily synthetically producible cationic polyelectrolytes, but is not based on completeness in respect of the possible and usable cationic polyelectrolytes or cationic polyelectrolyte mixtures.

The use of cationic polyelectrolytes or polyelectrolyte mixtures primarily depends on the thermal processing conditions under which the modified glass fibers are further processed in subsequent steps. Therefore, cationic polyelectrolytes or polyelectrolyte mixtures with low thermostability also cannot be used for processing at higher temperatures.

The following are preferably used as cationic polyelectrolytes or cationic polyelectrolyte mixtures: polyethyleneimine and/or polyallylamine and/or poly(amide-amine) and/or cationic maleimide copolymers and/or, in the use cases with a brief temperature load of <150° C. or a sustained temperature load of <100° C., chitosan.

The use of strong cationic polyelectrolytes with permanent charges, such as the polyDADMAC with quaternary ammonium groups for example, can occur independent of the pH.

If weak cationic polyelectrolytes are used which carry only primary and/or secondary and/or tertiary amino groups, which have permanent charges not independent of the pH, the process involves an addition of acid, preferably in the weakly acidic range from 4 to 6. Via conformation of the dissolved polycations through a repulsion of the identically charged groups, that is, of the generated ammonium groups, a development of the cationic polyelectrolyte macromolecule occurs, whereby is achieved a more effective attachment to the glass fiber surface, which is a weak anionic polyelectrolyte. The utilization of the polyelectrolyte effect is important for a most optimal and permanent possible attachment of polycations to the polyanionic glass fiber surfaces. The extended polycations used adsorb onto the oppositely charged glass fiber surfaces as thin films.

According to the invention, the cationic polyelectrolytes synthetically produced via polymerization and/or polycondensation must have molecular weights of <50,000 D (dalton), wherein molecular weights of <10,000 D (dalton) can more advantageously be present. The optimal range of the molecular weight for each specific cationic polyelectrolyte can be determined in a few trials. Molecular weights that are too high have proven unfavorable, since the optimal attachment and coverage of the glass fiber surface is not always free of problems with these cationic polyelectrolytes. With branched polyethyleneimine, for example, the molecular weight range from 400 Da to 10,000 Da has proven beneficial.

The production of the polycationically modified glass fiber surfaces preferably takes place directly during the glass fiber production in that, instead of the sizing material, the newly spun glass fibers are in the first stage treated/modified by means of immersion roller with a cationic polyelectrolyte and/or cationic polyelectrolyte mixture (depending on the cationic polyelectrolyte or polyelectrolyte mixture used, that is, depending on the type of polycation, the charge density in the macromolecule, the degree of branching, the type of cationic groups [amino or ammonium groups], the pH of the solution, and the molecular weight) and/or polyelectrolyte complex with an excess of cationic charges in an aqueous solution at a concentration of maximally 5.0 wt %, advantageously <2.0 wt % and preferably 0.1 wt % to 0.8 wt %, and the polyelectrolyte complex A is thus formed.

However, the surface modification of the glass fibers can also occur later in that the, in particular longer, glass fibers and/or short glass fibers or wound glass fibers (which for the surface modification are pulled through or stored in a bath, preferably in an unwound state) produced without a sizing material treatment (preferably still in a moist state, without or with a water-soluble lubricant, such as a surfactant or surfactant mixture and/or glycerin and/or polyethylene glycol for example, in order to improve the sliding properties) are treated, for example in a bath with a solution of hydrolysis-stable and/or solvolysis/stable, preferably unmodified, cationic polyelectrolyte and/or of a hydrolysis-stable and/or solvolysis-stable, preferably unmodified, cationic polyelectrolyte mixture and/or of a dissolved hydrolysis-stable and/or solvolysis-stable polyelectrolyte complex, produced from a cationic polyelectrolyte (mixture) and an anionic polyelectrolyte (mixture) with an excess of cationic charges, wherein if water-soluble lubricants are used, these lubricants dissolve and the cationic agents (cationic polyelectrolytes or cationic polyelectrolyte mixture and/or dissolved polyelectrolyte complex with an excess of cationic charges—hereinafter referred to as cationic agents) attach to the glass fiber surface or these lubricants are replaced by the cationic agents. In the case of short glass fibers, a stirred-tank reactor can also be used for this operation, for example, for modifying the surface with cationic agents.

Surprisingly, contrary to the statement from DE 2 315 245, Example 54, a complete and very stable coverage of the glass fiber surfaces was verified via pH-dependent zetapotential measurements for the cationic polyelectrolytes polyallylamine, polyethyleneimine (branched), poly(amide-amine), cationic copolymaleimide (produced from an alternating propene maleic anhydride copolymer, reacted with N,N-dimethylamino-n-propylamine and imidized) and a 1:1 mixture of polyethyleneimine (branched) and polyallylamine as well as polyDADMAC. As a further verification method for cationic agents with amino groups, the known addition reaction of the amino group-sensitive fluorescence marker fluorescamine was used for detection. Even an intensive washing with diluted acids or bases or a reflux heating or an extraction over several hours in water with diluted acetic acid also changed nothing about the analytical statements that the surface modification is present with optimal coverage.

What is referred to as the eosin test can be used as another rapid analysis. The samples are thereby stored in an aqueous eosin bath and are then thoroughly washed with distilled water.

When this eosin test is used on the modified glass fibers according to the invention, the coloring of the glass fiber is retained where the surface modification according to the invention is present.

An additional analysis can also take place using SEM/EDX.

For this purpose, the modified glass fibers according to the invention are treated with a copper(II) sulfate solution or a silver nitrate solution and are then thoroughly washed with distilled water. Via EDX, the element distribution at the glass fiber surface can be detected, wherein the metal ions must have a uniform distribution in a complexed state for the glass fiber surfaces according to the invention.

The hydrolysis-stable and/or solvolysis-stable, preferably unmodified, cationic polyelectrolytes and/or hydrolysis-stable and/or solvolysis-stable, preferably unmodified, cationic polyelectrolyte mixtures and/or hydrolysis-stable and/or solvolysis-stable polyelectrolyte complexes with an excess of cationic charges form with the glass fiber surface a hydrolytically and solvolytically stable polyelectrolyte complex A, which can be verified in pH-dependent zetapotential measurements by the stable position of the isoelectric point (at which the zetapotential=0). The position of the isoelectric point and the shape of the zetapotential curves before and after the washing or extracting are virtually congruent, which verifies the stability of this surface modification.

Compared to untreated glass fibers and commercial glass fibers treated with sizing material, both the position of the isoelectric point and also the shape of the zetapotential curves are different for the glass fibers surface-treated with cationic agents.

Depending on the hydrolysis-stable and/or solvolysis-stable cationic agents used, and above all depending on the degree of branching at pH levels <7, a largely mono(macro)molecular coverage of the glass fiber surface with cationic agents in the form of a thin film is achieved.

It has not yet been possible to achieve or verify a complete separation/elimination of the hydrolysis-stable and/or solvolysis-stable cationic agents applied according to the invention from the glass fiber surface.

A concentration of cationic agents that is too high or a pH>7 with weak cationic agents should be avoided, since in this case the attachment of the cationic agents to the glass fiber surface does not proceed in an optimal manner, that is, the coverage is not optimal, and a sort of “asymmetrical polyelectrolyte complex A” is formed with the glass surface, as it were.

The term “asymmetrical polyelectrolyte complex A” is understood as meaning a situation where a higher concentration of agents with cationic charges than agents with anionic charges is present in the polyelectrolyte complex and “asymmetrical polyelectrolyte complexes” that can be altered and stabilized by rearrangement are thus formed. In the present case, a higher concentration of agents with cationic charges than anionic glass fiber surface would be present, and would thus form an asymmetrical polyelectrolyte complex A.

Where concentrations of cationic agents are too high, the equilibrium reaction between the glass surface and cationic agents can, for example, be shifted towards a stable surface covering by a (subsequent) storage in water or a boiling or extracting with water, which can be used or utilized as a later practical corrective for an incorrect concentration of cationic agents and therefore deficient surface modification.

Via rearrangement reactions of the cationic agents at the glass fiber surface depending on the time, temperature, pH and salt concentration, a stabilization of the glass fiber surface to be modified with cationic agents towards an optimal and stable coverage is achieved. In a few trials, the ordinarily skilled artisan can determine the technological window, that is, the sufficiently optimal concentration, for the respective cationic agents in order to prevent a concentration that is too high and a re-treatment.

The glass fiber surfaces modified in such a manner can be further modified directly during the glass fiber production process or at a later point.

The glass fibers modified in such a manner can be further processed into a composite material directly following the glass fiber production process or at a later point.

Glass fibers can be modified according to the invention directly after the glass fiber production, or can even first be wound as roving and stored intermediately, for example, and then, having been modified according to the invention, be further processed into a composite material.

On the other hand, this modification during the further processing into the composite material according to the invention can also take place directly in the application, that is, during the processing with a matrix material in which, for example, the glass fiber surfaces modified according to the invention are reacted with a matrix material or a component of the matrix material.

The further processing can be carried out as follows:
(I) The hydrolysis hydrolysis-stable and/or solvolysis-stable cationic agents adsorbed to the glass fiber surface, which agents form the polyelectrolyte complex A, having for example amino groups (preferably primary and/or secondary and possibly tertiary amino groups) and possibly quaternary ammonium groups, are chemically coupled/modified with one or more at least difunctional or differently difunctionalized, low-molecular-weight and/or oligomeric and/or polymeric reagent(s), that is, with identical or different reactive and/or activatable functional groups, wherein at least one reactive and/or activatable functional group reacts with an amino group of the adsorbed cationic agents, with coupling thereby taking place, and at least one additional reactive and/or activatable functional group of the reagent(s) is specifically capable of/designed for a further chemical coupling and/or compatibilization with a matrix material or at least one component of a matrix material in the subsequent material system, and the coupling reaction(s) take place via reactions known to an ordinarily skilled artisan.
(II) The glass fiber surfaces modified with the hydrolysis-stable and/or solvolysis-stable cationic agents, which glass fiber surfaces form the polyelectrolyte complex A, are treated with an anionic polyelectrolyte and/or anionic polyelectrolyte mixture and/or a dissolved polyelectrolyte complex with an excess of anionic charges, which polyelectrolyte and/or polyelectrolyte mixture and/or polyelectrolyte complex has at least one reactive functional group that is identical to the anionic group and/or at least one reactive and/or activatable functional group that is different from the anionic group, for the subsequent chemical coupling and/or compatibilization with the matrix material or at least one component of the matrix material in the material system, and a “glass fiber surface/cationic polyelectrolyte/anionic polyelectrolyte” polyelectrolyte complex is formed (as polyelectrolyte complex B), wherein the cationic agents attached to the glass fiber surface have primary and/or secondary and/or tertiary amino groups which are preferably present in the acidic range, that is, in the pH range <7, as ammonium groups and/or have quaternary ammonium groups. This means that an anionic polyelectrolyte or an anionic polyelectrolyte mixture or a dissolved polyelectrolyte complex with an excess of anionic charges is attached to the polyelectrolyte complex A, whereby the polyelectrolyte complex B is created. The modification variant via the polyelectrolyte complex formation process is preferably used for cationic polyelectrolytes or cationic polyelectrolyte mixtures (cationic agents) with quaternary ammonium groups, but can also be used for cationic agents with amino groups and/or quaternary ammonium groups.
(III) The glass fibers modified with the hydrolysis-stable and/or solvolysis-stable cationic agents (as polyelectrolyte complex A), which fibers are still to be (further) processed in a textile processing operation, are, for the purpose of improving the workability, that is, the sliding and processing characteristics, treated with a lubricant (mixture), such as for example glycerin and/or starch and/or polyalkylene glycol (such as polyethylene glycol and/or polypropylene glycol and/or polyethylene-co-propylene glycol, for example) and/or non-ionic surfactants or surfactant mixtures and/or anionic surfactants or surfactant mixtures (hereinafter referred to as processing aid (mixture)), wherein the processing aid (mixture) attaches in such a manner to the glass surface modified with cationic agents that the textile processing can take place without problems. The attached processing aid (mixture) is to be selected such that, after the textile processing, this processing aid (mixture) can be removed again without significant problems via washing and/or extraction or is replaced, for example, via treatment with an anionic polyelectrolyte and/or anionic polyelectrolyte mixture and/or a dissolved polyelectrolyte complex with an excess of anionic charges, with a polyelectrolyte complex B thereby being formed, and the modified glass fiber surfaces processed in a textile operation are used in accordance with the object of the invention as reinforcing material and can be reacted with a matrix material, with chemical coupling and compatibilization thereby taking place.
(VI) The modified glass fibers with the hydrolysis-stable and/or solvolysis-stable polyelectrolyte complex B at the glass fiber surface, which fibers are still to be (further) processed in a textile processing operation, are, for the purpose of improving the workability, that is, the sliding and processing characteristics, treated with a lubricant (mixture), such as for example glycerin and/or starch and/or polyalkylene glycol (such as polyethylene glycol and/or polypropylene glycol and/or polyethylene-co-propylene glycol, for example) and/or non-ionic surfactants or surfactant mixtures and/or ionic surfactants or surfactant mixtures (hereinafter referred to as processing aid (mixture)), wherein the processing aid (mixture) attaches to the modified glass surface in such a manner that the textile processing can take place without problems. The attached processing aid (mixture) is to be selected such that, after the textile processing, this processing aid (mixture) can be removed again without significant problems via washing and/or extraction, and the modified glass fiber surfaces processed in a textile operation can be used in accordance with the object of the invention as reinforcing material and can be reacted with a matrix material, with chemical coupling and compatibilization thereby taking place.

The following are used, for example, as anionic polyelectrolytes or anionic polyelectrolyte mixtures, preferably dissolved in water:
(meth)acrylic acid copolymers which are present without and/or with at least one additional reactive and/or activatable functional group that is different from carboxylic acid and was introduced via the copolymerization, and/or which are present with at least one additional reactive and/or activatable functional group that is different from carboxylic acid and/or with at least one olefinically unsaturated double bond that are coupled via a polymer-analogous reaction/modification of the (meth)acrylic acid group, and which are preferably water-soluble, and/or
modified maleic acid (anhydride) copolymers which are preferably partially or completely present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of preferably maleic acid (anhydride) groups, and which are preferably water-soluble, and/or
modified itaconic acid (anhydride) (co)polymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of preferably itaconic acid (anhydride) groups, and which are preferably water-soluble, and/or
modified fumaric acid copolymers which are preferably present in the acid and/or monoester and/or monoamide form, and/or which are present without and/or with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of preferably fumaric acid groups, and which are preferably water-soluble, and/or
anionically modified (meth)acrylamide (co)polymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the preferably (meth)acrylamide group, and which are preferably water-soluble, and/or
sulfonic acid (co)polymers, such as for example styrenesulfonic acid (co)polymers and/or vinylsulfonic acid (co)polymers in acid and/or salt form, which are present with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of sulfonic acid groups, such as via sulfonic acid amide groups for example, and which are preferably water-soluble, and/or
(co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (co)polymer and which are preferably water-soluble.

The selection of the agents and the execution of the further processing, into the composite materials according to the invention, of the glass fiber surfaces modified with the hydrolysis-stable and/or solvolysis-stable cationic polyelectrolytes and/or cationic polyelectrolyte mixtures and/or with the hydrolysis-stable and/or solvolysis-stable polyelectrolyte complex with an excess of anionic charges takes place according to the chemical knowledge common for the ordinarily skilled artisan and is explained in greater detail in the examples using a few specific embodiments.

Within the scope of the present invention, reactive functional groups for coupling reactions are to be understood as groups, such as for example isocyanates, epoxy groups, anhydrides, acid chlorides, acrylic acid derivatives (for the Michael-analogous addition), which directly react with amino groups of the polyelectrolyte complex A or with functional groups of the polyelectrolyte B without any additional activation.

Within the scope of the present invention, activatable functional groups for coupling reactions are to be understood as groups, such as for example blocked isocyanates, urethane groups, uretdione groups, allophanate groups, biuret groups, chlorohydrin groups, ester groups, which react with amino groups of the polyelectrolyte complex A or with functional groups of the polyelectrolyte complex B after a thermal and/or catalytic activation.

Furthermore, within the scope of the present invention, activatable functional groups for coupling reactions are to be understood as meaning olefinically unsaturated double bonds that are capable of grafting reactions, coupling reactions and polymerization reactions which react with the polyelectrolyte complex A or polyelectrolyte complex B, with coupling thereby taking place, after a thermal and/or radical and/or catalytic activation in the composite material system.

The use of cationic polyelectrolytes and/or cationic polyelectrolyte mixtures and/or polyelectrolyte complexes with an excess of cationic charges that have, in a manner similar to the prior art, been produced prior to the application during the glass fiber production process and do not have any silane groups, and which are modified/equipped with specific functional groups for reaction and/or compatibilization with a matrix material or at least one component of the matrix material and/or are equipped with functions, such as those for improving the sliding properties via amidation with fatty acids for example, has proven less effective in terms of the attachment and optimal coverage density on the glass fiber surface and with regard to the reinforcing effect, since in this case the direct attachment to and interaction with the glass fiber surface, mostly interfered with by steric effects, is impaired.

The subsequent chemical modification of the glass fiber surfaces modified with the hydrolysis-stable and/or solvolysis-stable cationic polyelectrolytes and/or cationic polyelectrolyte mixtures and/or the hydrolysis-stable and/or solvolysis-stable polyelectrolyte complexes with an excess of cationic charges is considered to be the optimal variant based on experimental analyses.

The advantages of these glass fibers modified with the hydrolysis-stable and/or solvolysis-stable cationic polyelectrolytes and/or cationic polyelectrolyte mixtures and/or the hydrolysis-stable and/or solvolysis-stable polyelectrolyte complexes with an excess of anionic charges, which glass fibers are not primarily intended for a textile processing operation, are that the modified glass fibers according to the invention produced according to the invention after the first modification stage can be directly used as reinforcing material, or can be further processed directly and/or downstream in one or more processing stages as reinforcing material specifically tailored/modified for the subsequent application.

For direct use as reinforcing material, the modified glass fibers according to the invention are reacted with a matrix material or a component of a matrix material directly in the application/use case; that is, the fibers are chemically coupled or, after a reaction with modifying agent(s) that is/are or was/were contained in the matrix material or was admixed with the matrix material, then chemically coupled/compatibilized with the matrix material, such as for example for the use of glass fibers surface-modified with cationic polyelectrolytes or cationic polyelectrolyte mixtures as reinforcing material:
in epoxy resins or
in polyurethane materials (PUR/polyurethane or TPU/thermoplastic polyurethane) or
in UP resins for SMC materials, wherein the glass fibers with the polyelectrolyte complex A or polyelectrolyte complex B are modified with a chemically coupled reactive component having olefinically unsaturated double bonds (such as for example glycidyl methacrylate (GMA) and/or (meth)acrylic anhydride and/or (meth)acrylic chloride and/or allyl glycidyl ether and/or tetrahydrophthalic anhydride and/or maleic anhydride and/or itaconic anhydride) which are capable of radical coupling, that is, of reacting with the unsaturated matrix component(s),
in UP resins or SMC materials, wherein an olefinically unsaturated reactive component (such as for example glycidyl methacrylate (GMA) and/or (meth)acrylic anhydride and/or (meth)acrylic chloride and/or allyl glycidyl ether and/or tetrahydrophthalic anhydride and/or maleic anhydride and/or itaconic anhydride) was added to the UP or SMC resin mixture for the reaction and coupling with amino groups of the polyelectrolyte complex A, that is, with amino groups of the cationic polyelectrolyte or cationic polyelectrolyte mixture attached to the glass fiber surface and for the radical coupling reaction with the unsaturated matrix component(s).

In the case of the surface modification of the glass fibers according to the invention with polymers having quaternary ammonium groups in the polyelectrolyte complex A that are not capable of chemically reactive coupling, as in the case of the poly(diallyldimethylammonium chloride) (polyDADMAC), a specifically modified anionic polyelectrolyte or an anionic polyelectrolyte mixture is attached and fixed as polyelectrolyte B in a second method step for activation. This anionic polyelectrolyte or anionic polyelectrolyte mixture or polyelectrolyte complex with an excess of anionic charges, which polyelectrolyte or polyelectrolyte mixture or polyelectrolyte complex can also be modified with specific functional groups for the reaction and/or compatibilization with matrix materials and/or equipped with functions, such as those for improving the sliding properties for example, are commercially available on a wide scale, for example, as (meth)acrylic acid copolymer derivatives and/or (modified) maleic acid (anhydride) copolymer derivatives and/or (modified) itaconic acid (anhydride) (co)polymer derivatives and/or (modified) fumaric acid copolymer derivatives and/or styrenesulfonic acid (co)polymer derivatives and/or anionically equipped acrylamide (co)polymer derivatives. The ordinarily skilled artisan can in this case draw on a plurality of commercial products that are not individually listed here.

However, the glass fiber surfaces modified with the hydrolysis-stable and/or solvolysis-stable cationic polyelectrolyte and/or cationic polyelectrolyte mixture and/or hydrolysis-stable and/or solvolysis-stable polyelectrolyte complexes with an excess of cationic charges can also be treated in a subsequent modification, for example with anionically modified sizing material, such as for example anionic starch or sizing material formulations with anionic sizing material components and/or anionic surfactants and, in the simplest case, with stearic acid, and can thus be subsequently equipped with corresponding sliding and processing properties for a textile-technical further processing.

The essential feature of this invention is that the glass fiber surface is in the first step equipped with a most mono(macro)molecular possible layer of a hydrolysis-stable and/or solvolysis-stable polyelectrolyte complex A with a layer thickness on the nanometer scale as a base material without the use of sizing material and/or silane, and is used in this form or is in subsequent steps chemically modified or equipped via an attachment of a specific anionic polyelectrolyte or anionic polyelectrolyte mixture for producing a polyelectrolyte complex B and/or C, D, E, etc. for the respective use case. The glass fiber surfaces modified in a hydrolysis-stable and/or solvolysis-stable manner thus form a universal base material.

Surprisingly, it was also discovered that the cationic polyelectrolytes and/or cationic polyelectrolyte mixtures and/or polyelectrolyte complexes with an excess of cationic charges, which polyelectrolytes and/or polyelectrolyte mixtures and/or polyelectrolyte complexes are attached to the glass fiber surface, form a very stable polyelectrolyte complex A, and that the polyelectrolyte complex A can no longer be destroyed or separated from the glass surface by typical dissolving and/or extraction processes.

A partial to virtually complete separation of hydrolysis-stable and/or solvolysis-stable cationic polyelectrolytes of the polyelectrolyte complex A and/or of (polyelectrolyte) components of the hydrolysis-stable and/or solvolysis-stable polyelectrolyte complex B from the glass fiber surface would only be possible with an excess of stronger polyelectrolytes in that, in an equilibrium reaction in an aqueous environment, the polyelectrolyte complex A and/or the polyelectrolyte complex B, via formation of a separate polyelectrolyte complex, essentially connects to this stronger polyelectrolyte and thus “rearranges” and separates from the glass surface.

Analogously, a weak cationic polyelectrolyte or cationic polyelectrolyte mixture attached to the glass surface and/or an attached weak polyelectrolyte complex can also be partially to completely exchanged for a stronger cationic polyelectrolyte or cationic polyelectrolyte mixture having, for example, quaternary ammonium groups if an excess of strong cationic polyelectrolyte is introduced into the exchange reaction.

Furthermore, it was discovered that glass fibers already commercially produced and sized can also be subsequently modified with the hydrolysis-stable and/or solvolysis-stable cationic polyelectrolyte or cationic polyelectrolyte mixture to form a polyelectrolyte complex A on the glass fiber surfaces that are free (of silane and/or sizing material), and can thus be further processed into a composite material according to the invention with the subsequent reactions described according to the invention, since these glass fibers have surfaces that are for most of the part composed of pure, unmodified glass fiber surface, which is verified by SEM images. Thus, glass fiber products of this type can also be retrofitted for specific applications, which was neither known nor practiced before.

The glass fibers specifically modified with the hydrolysis-stable and/or solvolysis-stable cationic polyelectrolytes or cationic polyelectrolyte mixtures as polyelectrolyte complex A and/or with the hydrolysis-stable and/or solvolysis-stable polyelectrolyte complex B, which glass fibers have a high to complete degree of coverage, are preferably used as short glass fiber or long glass fiber reinforcing material for thermoplastics, elastomers or thermosets, or as a mat or as glass fiber fabric reinforcing material, for example, for lightweight constructions. It is advantageous if the glass fibers modified in such a manner are reacted with the matrix material or a component of the matrix material, whereby it is directly coupled with the matrix material and/or equipped with functionalities specifically for coupling with a matrix material or a component of the matrix material.

The invention also relates to a method for producing glass fiber surfaces modified according to the invention without sizing material and silane as a precursor to the production of a composite material specifically tailored to the respective matrix, which composite material is available for further processing into thermoplastic and/or elastomeric and/or thermosetting compounds directly afterwards or after the glass fiber production. With the method according to the invention, the commercial sizing material treatment is replaced by a specific surface and processing modification of glass fibers with a hydrolysis-stable and/or solvolysis-stable cationic polyelectrolyte or cationic polyelectrolyte mixture as polyelectrolyte complex A and/or with a hydrolysis-stable and/or solvolysis-stable polyelectrolyte complex B, preferably during and/or after the glass fiber production, wherein previously sized glass fiber products can also still be subsequently equipped/modified accordingly, and can thus be upgraded in terms of quality.

Within the scope of the present invention, polyelectrolytes are to be understood as meaning water-soluble compounds with a long chain length (polymers) that carry anionic (polyacids) or cationic (polybases) dissociable groups (Wikipedia, German-language keyword “Polyelektrolyte”).

The adsorption of polyelectrolytes of this type occurs in that dissolved polyelectrolytes are adsorbed onto oppositely charged surfaces. The adsorption is driven, among other things, by the electrostatic attraction between the charged monomer units of the polyelectrolytes and oppositely charged, dissociated surface groups on the glass fiber surface (for example, SiO groups on silicon dioxide surfaces). However, the release of counterions or the formation of hydrogen bonds also enable adsorption. The conformation of the polyelectrolyte in a dissolved state determines the amount of adsorbed substance. Extended polyelectrolyte molecules adsorb onto the surface as thin films (0.2 nm-1 nm), whereas coiled polyelectrolyte molecules form thicker layers (1 nm-8 nm).

In contrast to the prior art, a considerably more stable, materially bonded covering of the glass fiber surfaces is achieved with a higher degree of coverage, and stable compounds dissolved in water are used which are not altered during the application. Furthermore, no sizing material mixtures or sizing material dispersions are used, nor are silanes necessary for the coupling with the glass fiber surface, which silanes chemically change in water as a function of time.

The invention is explained below in greater detail with the aid of several exemplary embodiments.

Throughout the examples, the production and modification of glass fibers takes place on an E-glass spinning system on a pilot-plant scale for the spinning and on-line surface modification of glass fibers. The system has sizing stations, which can be used downstream for multi-stage application immediately following the spinning process, and a direct roving winder.

After the cleaning of the sizing station, the tub is filled with an aqueous solution of
a hydrolysis-stable and/or solvolysis-stable unmodified cationic polyelectrolyte, or
a hydrolysis-stable and/or solvolysis-stable unmodified cationic polyelectrolyte mixture, or
a hydrolysis-stable and/or solvolysis-stable cationic polyelectrolyte, or
a hydrolysis-stable and/or solvolysis-stable cationic polyelectrolyte mixture.

Depending on the draw-off speed, filament yarns of 50 to 200 tex can be spun using the system.

### EXAMPLE 1

In the E-glass silk spinning system, glass fibers with 100 tex are spun and are surface-modified and wound in the “sizing station,” which is filled with an aqueous 0.5% PEI solution as cationic polyelectrolyte (PEI=polyethyleneimine, Aldrich, Mₙ=10,000).

The pH-dependent zetapotential measurements on the glass fibers treated in such a manner verify the adsorption of PEI in the polyelectrolyte complex A with the glass fiber surface.

The detection of coupled amino groups at the surfaces and verification of the uniform coverage of the glass fibers was conducted using the fluorescamine method.

The surface-modified glass fibers comprise the polyelectrolyte complex A that was formed from the glass fiber surface and PEI.

### EXAMPLE 1A: COUPLING WITH EPOXY COMPOUNDS

A bundle of glass fiber segments (length of 20 mm) was treated with 3,5-dibromophenyl glycidyl ether in ethanol. After the washing, the sample showed in the EDX analyses a uniformly thick coverage with bromine at the glass fiber surface.

The treatment with the 3,5-dibromophenyl glycidyl ether verifies the reactivity of the glass fiber surface modified with PEI with respect to epoxy resins and verifies the uniform coverage.

### EXAMPLE 1B: COUPLING WITH ISOCYANATE AND ISOCYANATE DERIVATIVES

Analogously, a bundle of glass fiber segments (length of 20 mm) was dried and treated with 2,4-dibromophenyl isocyanate in ether. After the washing with acetone, the sample showed in the EDX analyses a uniformly thick coverage with bromine at the glass fiber surface.

The treatment with the 2,4-dibromophenyl isocyanate verifies the reactivity of the glass fiber surface modified with PEI with respect to isocyanate compounds, which verifies that these glass fiber products can be used for the reinforcement of PUR and TPU.

### EXAMPLE 1C: COUPLING WITH EPOXY RESIN

In accordance with the method for examining the fiber/matrix adhesion (fiber pull-out method), a glass fiber was embedded in epoxy resin and the pull-out force was determined. With the glass fibers surface-modified with PEI, it was possible to determine a 40% on-average increase in the pull-out force compared to commercially sized glass fibers.

The embedding furthermore verifies the good bonding and coupling of the PEI surface-modified glass fibers with epoxy resin, and verifies that these glass fiber products can be used for the reinforcement of epoxy resins.

### EXAMPLE 1D: COUPLING WITH OLEFINICALLY UNSATURATED MONOMERS

5 g of glass fiber segments approx. 20 mm long were treated on a fit with 20 mL of a 0.1% glycidyl methacrylate (GMA)/ethanol solution and the solution was suctioned away. The glass fiber segments were rinsed with ethanol three times and dried. The glass fibers treated in such a manner were degassed and rendered oxygen-free in a 250 mL three-neck flask by means of vacuum application and high-purity nitrogen flushing. Then, a prepared polymerization solution (composed of 100 mL pure toluene distilled under nitrogen, 5 mL destabilized styrene and 50 mg AIBN (azobis(2-methylpropionitrile)) was added under high-purity nitrogen and was reacted with the glass fibers for 3 hours at 50° C. while being stirred. The solution is suctioned away, and the glass fibers are extracted three times with toluene under reflux and subsequently dried in a vacuum. In the ATR spectrum, a non-extractable, chemically coupled polystyrene was detected on the glass fibers, whereby it is verified that, after a GMA treatment with UP resins, these PEI surface-modified glass fibers can be used in SMC production, for example.

Additional trials have shown that this pretreatment is not necessary if corresponding agents, such as for example GMA and/or allyl glycidyl ether and/or (meth)acrylic anhydride and/or (meth)acrylic chloride, are added to the polymerization system/polymerization solution or the UP resin, which agents on the one hand react with the PEI on the glass fiber surface and on the other hand are capable of a radical coupling reaction/copolymerization.

### EXAMPLE 1E: GALVANIZATION OF A PEI-MODIFIED GLASS FIBER SURFACE

5 g of glass fiber segments surface-modified with PEI and approx. 20 mm long are stirred for 15 minutes in 100 mL of an aqueous nucleating agent solution temperature-controlled to 50° C. (composed of 1 g/L PdCl₂ and 20 g/L HCl) and suctioned. Palladium nuclei/noble metal nuclei are then produced by a reduction of the palladium ions in a formaldehyde solution. A nickel conductive layer is subsequently applied via chemically reductive deposition to the surface activated in such a manner, which verifies that PEI surface-modified glass fibers can be electrochemically coated with metal at the surface.

### EXAMPLE 1F: GALVANIZATION OF A GLASS FIBER SURFACE MODIFIED WITH POLYELECTROLYTE COMPLEX B

As in Example 1e, palladium nuclei/noble metal nuclei are produced on 5 g of glass fiber segments surface-modified with PEI and approx. 20 mm long. After the rinsing, these glass fibers are then treated with a 0.1% propene-alt-maleic acid n-butylmonoamide solution (produced from propene-alt-maleic anhydride via reaction with n-butylamine in water) for the formation of a polyelectrolyte complex B at the surface. The glass fibers are suctioned and rinsed and the nickel conductive layer is applied via chemically reductive deposition to the glass fiber surfaces activated in such a manner, which verifies that surface-modified glass fibers can be electrochemically coated with metal at the surface.

### EXAMPLE 2

As in Example 1, glass fibers with 100 tex are spun in the E-glass silk spinning system and are surface-modified and wound in the “sizing station,” which is filled with an aqueous 0.5% polyDADMAC solution as a cationic polyelectrolyte (polyDADMAC=poly(diallyldimethylammonium chloride), Aldrich, M_{W}<100,000).

The pH-dependent zetapotential measurements on the glass fibers treated in such a manner verify the adsorption of polyDADMAC onto the surface.

The surface-modified glass fibers comprise the polyelectrolyte complex A that was formed from the glass fiber surface and polyDADMAC.

Since polyDADMAC as a strong cationic polyelectrolyte the has only quaternary ammonium groups and otherwise no additional olefinically unsaturated double bonds and/or reactive functional groups that are relevant for chemical radical reactions, addition reactions and substitution reactions, direct reactions are not possible. In this case, for further modification, the glass fiber surface-modified with polyDADMAC is treated with an anionic polyelectrolyte which has an additional functional group, which is different from the anionic group, for the chemical coupling and/or compatibilization with the matrix material or at least one component of the matrix material, and a polyelectrolyte complex B (“glass fiber surface/polycation/polyanion”) is formed. This modification variant via the polyelectrolyte complex formation process is used for the glass fibers surface-modified with polyDADMAC.

### EXAMPLE 2A: COUPLING WITH OLEFINICALLY UNSATURATED MONOMERS

The glass fiber surface-modified with polyDADMAC is treated in a separate step downstream of the production process with a 0.3% propene-alt-maleic acid n-allylmonoamide solution as an anionic polyelectrolyte (produced from propene-alt-maleic anhydride via reaction with n-allylamine in water at a 1 to 0.4 ratio of maleic anhydride group to allyl amine) for the formation of a polyelectrolyte complex B.

Glass fiber segments modified in such a manner and approx. 20 mm long were rinsed with ethanol three times and dried. 10 g of these glass fibers were degassed and rendered oxygen-free in a 250 mL three-neck flask by means of vacuum application and high-purity nitrogen flushing. Then, a prepared polymerization solution (composed of 100 mL pure toluene distilled under high-purity nitrogen, 5 mL destabilized styrene and 50 mg AIBN (azobis(2-methylpropionitrile)) was added under nitrogen and was reacted with the glass fibers for 5 hours at 50° C. while being stirred. The solution is suctioned away, and the glass fibers are extracted three times with toluene under reflux and subsequently dried in a vacuum. In the ATR spectrum, a chemically coupled polystyrene not extractable from the glass fibers was detected, whereby it is verified that surface-modified glass fibers of this type can be used with UP resins in SMC production, for example.

### EXAMPLE 2B: COUPLING WITH HOT-CURING EPOXY RESIN

Analogously to Example 2a, the glass fiber surface-modified with polyDADMAC is treated with a 0.2% propene-alt-maleic acid monoethyl ester solution as anionic polyelectrolyte (produced from propene-alt-maleic anhydride via reaction in ethanol under reflux, precipitated in water, decanted and once again dissolved in water with NaOH being added) for the formation of a polyelectrolyte complex B.

5 g of surface-modified glass fiber segments were stirred into 20 mL of a mixture of hot-curing epoxy resin (epoxy resin for FR-4 production) and briefly heated to 160° C. so that the resin continued to stay liquid. After the cooling, this glass fiber/resin mixture was treated with MEK (methyl ethyl ketone), and the glass fibers were passed through a frit and washed with hot MEK. The glass fibers treated in such a manner were dried and examined by means of ATR. It was possible to detect coupled epoxy resin residues on the glass fiber surface, which verifies that a coupling of the surface-modified glass fibers with hot-curing epoxy resin took place, and that these glass fiber products can be used for the reinforcement of hot-curing epoxy resins.

### EXAMPLE 2C: COUPLING WITH COLD-CURING EPOXY RESIN

Analogously to Example 2a, the glass fiber surface-modified with polyDADMAC is treated with a 0.5% propene-alt-maleic acid N,N-dimethylamino-n-propylmonoamide solution as an anionic polyelectrolyte (produced from propene-alt-maleic anhydride via reaction with N,N-dimethylamino-n-propylamine in water) for the formation of a polyelectrolyte complex B.

5 g of surface-modified glass fiber segments were stirred in 20 mL of a mixture of MEK (methyl ethyl ketone) and bisphenol A diglycidyl ether (MEK/epoxy resin=1/1), and this was stirred for 15 minutes at 50° C. The glass fiber/resin mixture was diluted with MEK, and the glass fibers were passed through a frit and washed with hot MEK. The glass fibers treated in such a manner were dried and examined by means of ATR. Coupled epoxy resin residues were detected on the glass fiber surface, which verifies that a coupling of these surface-modified glass fibers with epoxy resin took place, and that these glass fiber products can be used for the reinforcement of cold-curing epoxy resins.

### EXAMPLE 2D: GALVANIZATION OF A GLASS FIBER SURFACE MODIFIED WITH POLYELECTROLYTE COMPLEX B

Palladium nuclei/noble metal nuclei are produced by immersion and reduction on 10 g of glass fiber segments surface-modified with polyDADMAC and approx. 20 mm long. These glass fibers are treated with a 0.1% propene-alt-maleic acid-n-butylmonoamide solution as an ionic polyelectrolyte (produced from propene-alt-maleic anhydride via reaction with N-butylamine in water) for the formation of a polyelectrolyte complex B at the surface. The glass fibers are suctioned and rinsed and the nickel conductive layer is applied via chemically reductive deposition to the glass fiber surfaces activated in such a manner, which verifies that surface-modified glass fibers can be electrochemically coated with metal at the surface.

### EXAMPLE 3

Analogously to Example 1, in the E-glass silk spinning system glass fibers with 150 tex are spun, and are surface-modified and wound in the “sizing station,” which is filled with an aqueous 0.8% PEI/polyallylamine solution as a cationic polyelectrolyte (PEI=polyethyleneimine, Aldrich, Mₙ=10,000, polyallylamine, Aldrich, M_{w}˜15,000; PEI/polyallylamine=2/1).

The pH-dependent zetapotential measurements on the glass fibers treated in such a manner verify the adsorption of PEI/polyallylamine in the polyelectrolyte complex A with the glass fiber surface.

The detection of coupled amino groups at the surfaces and verification of the uniform coverage of the glass fibers was conducted using the fluorescamine method.

The surface-modified glass fibers comprise the polyelectrolyte complex A that was formed from the glass fiber surface and the cationic PEI/polyallylamine polyelectrolyte mixture.

### EXAMPLE 3A: COUPLING WITH EPOXY RESIN

In accordance with the method for examining the fiber/matrix adhesion (fiber pull-out method), a glass fiber was embedded in epoxy resin and the pull-out force was determined. With the glass fibers surface-modified with PEI/polyallylamine, it was possible to determine a 30% on-average increase in the pull-out force compared to commercially sized glass fibers.

The embedding verifies the good bonding and coupling of the surface-modified glass fibers with epoxy resins, and verifies that these glass fiber products can be used for the reinforcement of epoxy resins.

### EXAMPLE 3B: COUPLING WITH ISOCYANATE AND ISOCYANATE DERIVATIVES

Analogously, a bundle of dried glass fiber segments (length of 20 mm) was treated with 2,4-dibromophenyl isocyanate in ether. After the washing with acetone, the sample showed in the EDX analyses a uniform coverage of the glass fiber surface with bromine.

In addition to the uniform coverage, the treatment with the 2,4-dibromophenyl isocyanate furthermore verifies the reactivity of the glass fiber surface with respect to isocyanate compounds, which verifies that the glass fiber products surface-modified in such a manner can be used for the reinforcement of PUR and TPU.

### EXAMPLE 3C: COUPLING WITH OLEFINICALLY UNSATURATED MONOMERS

5 g of glass fiber segments approx. 20 mm long were degassed and rendered oxygen-free in a 250 mL three-neck flask by means of vacuum application and high-purity nitrogen flushing. Then, a prepared polymerization solution (composed of 100 mL pure toluene distilled under high-purity nitrogen, 5 mL destabilized styrene, 0.2 mL GMA (glycidyl methacrylate) and 50 mg AIBN (azobis(2-methylpropionitrile)) were added under nitrogen atmosphere and this was reacted with the glass fibers for 3 hours at 50° C. while being stirred. The solution is suctioned away, and the glass fibers were extracted three times with toluene under reflux and subsequently vacuum dried. In the ATR spectrum, a non-extractable, chemically coupled polystyrene was detected on the glass fibers, whereby it is verified that these PEI/polyallylamine surface-modified glass fibers couple with the GMA in the polymerization system and the glass fibers that are GMA-modified in situ copolymerize with styrene; that is, according to the remarks in Example 1d the in situ modification can also be used with UP resins in SMC production, for example.

### EXAMPLE 4

From a commercial glass fiber roving with 100 tex, 10 g of glass fiber segments with a length of 20 mm are cut off, placed in a 100 mL Erlenmeyer flask and treated for 30 minutes with 50 mL of an aqueous 1.0% PEI solution (PEI=polyethyleneimine, Aldrich, Mₙ=10,000) while being stirred with a magnetic stirrer. The aqueous PEI solution is than decanted, the Erlenmeyer flask is filled with 50 mL distilled water, and these glass fibers are suctioned by means of a frit and washed three times with water and twice with methanol and dried.

The pH-dependent zetapotential measurements on the glass fibers treated in such a manner verify the adsorption of PEI with the glass fiber surface to form the polyelectrolyte complex A in comparison to the untreated starting material (glass fiber roving).

The detection of coupled amino groups at the surfaces of the glass fibers was conducted using the fluorescamine method.

The surface-modified glass fibers comprise the polyelectrolyte complex A that was formed from the glass fiber material and PEI.

### EXAMPLE 4A: COUPLING WITH EPOXY RESIN

Individual glass fiber segments were treated with 3,5-dibromophenyl glycidyl ether in ethanol. After the washing with ethanol, the sample showed in the EDX analyses a uniform coverage of the glass fiber surface with bromine.

This experiment furthermore verifies the reactivity of this post-treated glass fiber surface with respect to epoxy compounds, that is, epoxy resins.

### EXAMPLE 4B: COUPLING WITH ISOCYANATE AND ISOCYANATE DERIVATIVES

Analogously, dried glass fiber segments (length of 20 mm) were treated with 2,4-dibromophenyl isocyanate in ether. After the washing with acetone, the sample showed in the EDX analyses a uniform coverage of the glass fiber surface with bromine.

### EXAMPLE 4C: COUPLING WITH OLEFINICALLY UNSATURATED MONOMERS

5 g of glass fiber segments post-treated with PEI solution and approx. 20 mm long were degassed and rendered oxygen-free in a 250 mL three-neck flask by means of vacuum application and high-purity nitrogen flushing. Then, a prepared polymerization solution (composed of 100 mL pure toluene distilled under nitrogen, 5 mL destabilized styrene, 0.2 mL GMA (glycidyl methacrylate) and 50 mg AIBN (azobis(2-methylpropionitrile)) was added under high-purity nitrogen and reacted with the glass fibers for 3 hours at 50° C. while being stirred. The solution is suctioned away, and the glass fibers are extracted three times with toluene under reflux and subsequently dried in a vacuum. In the ATR spectrum, a non-extractable, chemically coupled polystyrene was detected on the glass fibers, whereby it is verified that these post-treated, surface-modified glass fibers reactively couple with GMA and copolymerize in the polymerization system, that is, that commercial glass fibers post-treated in such a manner can also be used in SMC production, for example.

1. Glass fiber surfaces modified without sizing material and silane, which glass fiber surfaces are at least partially covered at least with a hydrolysis-stable and/or solvolysis-stable cationic polyelectrolyte and/or hydrolysis-stable and/or solvolysis-stable cationic polyelectrolyte mixture and/or a hydrolysis-stable and/or solvolysis-stable polyelectrolyte complex and coupled to the glass fiber surface via a (polyelectrolyte) complex formation process by means of ionic bonding, thereby forming the polyelectrolyte complex A.

2. The glass fiber surfaces modified without sizing material and silane according to claim 1 in which a hydrolysis-stable and/or solvolysis-stable polyelectrolyte complex A is present which has been created
by a (polyelectrolyte) complex formation of the glass fiber surface with hydrolysis-stable and/or solvolysis-stable cationic polyelectrolytes; and/or
by a (polyelectrolyte) complex formation of the glass fiber surface with hydrolysis-stable and/or solvolysis-stable cationic polyelectrolyte mixtures; and/or
by a (polyelectrolyte) complex formation of the glass fiber surface with hydrolysis-stable and/or solvolysis-stable polyelectrolyte complexes having an excess of cationic charges, which polyelectrolyte complexes have been produced before being applied to the glass fiber surface.

3. The glass fiber surfaces modified without sizing material and silane according to claim 1 in which the hydrolysis-stable and/or solvolysis-stable polyelectrolyte complex A covers the glass fiber surface completely or essentially completely.

4. The glass fiber surfaces modified without sizing material and silane according to claim 1 in which the following are present as hydrolysis-stable and/or solvolysis-stable cationic polyelectrolyte or hydrolysis-stable and/or solvolysis-stable cationic polyelectrolyte mixture:
poly(diallyldimethylammonium chloride) (polyDADMAC) and/or copolymers; and/or
polyallylamine and/or copolymers; and/or
polyvinylamine and/or copolymers; and/or
polyvinylpyridine and/or copolymers; and/or
polyethyleneimine (linear and/or branched) and/or copolymers; and/or
chitosan; and/or
poly(amide-amine) and/or copolymers; and/or
cationically modified poly(meth)acrylate(s) and/or copolymers; and/or
cationically modified poly(math)acrylamide(s) with amino groups, and/or copolymers; and/or
cationically modified maleimide copolymer(s), produced from maleic acid (anhydride) copolymer(s) and (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and (N,N-dialkylaminoalkylene)amine(s); and/or
cationic starch derivatives and/or cellulose derivatives.

5. The glass fiber surfaces modified without sizing material and silane according to claim 1 in which the following are present as functionalities on the hydrolysis-stable and/or solvolysis-stable cationic polyelectrolyte or hydrolysis-stable and/or solvolysis-stable cationic polyelectrolyte mixture:
unmodified primary and/or secondary and/or tertiary amino groups that do not have substituents on the amine nitrogen atom with an additional reactive and/or activatable functional group and/or olefinically unsaturated double bond, and/or quaternary ammonium groups which do not have on the nitrogen atom substituents with an additional reactive and/or activatable functional group and/or olefinically unsaturated double bond, and/or
have amino groups and/or quaternary ammonium groups which are at least partially chemically modified on the nitrogen atom via alkylation reactions, with at least one additional reactive and/or activatable functional group and/or at least one olefinically unsaturated double bond,
and/or
have amino groups and/or quaternary ammonium groups and amide groups which are chemically modified via acylation reactions of amino groups to amide, with at least one additional reactive and/or activatable functional group and/or at least one olefinically unsaturated double bond.

6. The glass fiber surfaces modified without sizing material and silane according to claim 1 in which at least one anionic polyelectrolyte or one anionic polyelectrolyte mixture without and/or with at least one additional reactive and/or activatable functional group different from the anionic group and/or with at least one olefinically unsaturated double bond are present as functionalities on the hydrolysis-stable and/or solvolysis-stable cationic polyelectrolyte or hydrolysis-stable and/or solvolysis-stable cationic polyelectrolyte mixture attached to the glass fiber surface.

7. The glass fiber surfaces modified without sizing material and silane according to claim 6 in which the following are present as anionic polyelectrolyte or anionic polyelectrolyte mixture:
(a) (meth)acrylic acid copolymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylic acid group, and which are preferably water-soluble, and/or
(b) modified maleic acid (anhydride) copolymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of maleic acid (anhydride) groups, and which are preferably water-soluble, and/or
(c) modified itaconic acid (anhydride) (co)polymers which are preferably present in the acid and/or monoester and/or monoamide and/or water-soluble imide form, and/or which are present without and/or with residual anhydride groups, and/or which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of itaconic acid (anhydride) groups, and which are preferably water-soluble, and/or
(d) modified fumaric acid copolymers which are preferably present in the acid and/or monoester and/or monoamide form, and/or which are present without and/or with at least one additional reactive and/or activatable functional group that was introduced via the copolymerization, and or which are present with at least one additional reactive and/or activatable functional group and/or at least one olefinically unsaturated double bond that are coupled via a polymer-analogous reaction/modification of fumaric acid groups, and which are preferably water-soluble, and/or
(e) anionically modified (meth)acrylamide (co)polymers which are present without and/or with at least one additional reactive and/or activatable functional group that was introduced via the copolymerization, and/or which are present with at least one additional reactive and/or activatable functional group and/or with at least one olefinically unsaturated double bond that are coupled via a polymer-analogous reaction/modification of the (meth)acrylamide group, and which are preferably water-soluble, and/or
(f) sulfonic acid (co)polymers, such as for example styrenesulfonic acid (co)polymers and/or vinylsulfonic acid (co)polymers in acid and/or salt form, which are present with at least one additional reactive and/or activatable functional group that was introduced via the copolymerization, and/or which are present with at least one additional reactive and/or activatable functional group and/or at least one olefinically unsaturated double bond that are coupled via a polymer-analogous reaction/modification of sulfonic acid groups, such as via sulfonic acid amide groups for example, and which are preferably water-soluble, and/or
(g) (co)polymers with phosphonic acid groups and/or phosphonate groups, which are for example present such that they are bonded as aminomethylphosphonic acid and/or aminomethylphosphonate and/or amidomethylphosphonic acid and/or amidomethylphosphonate, and/or which are present with at least one additional reactive and/or activatable functional group that was introduced via the copolymerization, and/or which are present with at least one additional reactive and/or activatable functional group and/or with at least one olefinically unsaturated double bond that are coupled via a polymer-analogous (co)polymer reaction/modification, and which are preferably water-soluble.

8. The glass fiber surfaces modified without sizing material and silane according to claim 1 in which the hydrolysis-stable and/or solvolysis-stable cationic polyelectrolytes or the hydrolysis-stable and/or solvolysis-stable cationic polyelectrolyte mixture have a molecular weight under 50,000 dalton, preferably in the range between 400 and 10,000 dalton.

9. Composite materials with glass fibers having glass fiber surfaces modified without sizing material and silane, in which composite materials hydrolysis-stable and/or solvolysis-stable polyelectrolyte complexes A and/or B, which are present in an at least partially covering manner on glass fiber surfaces without sizing material and silane and which comprise functional groups and/or olefinically unsaturated double bonds, are present such that they are coupled via a chemically covalent bond with additional materials after a reaction with functional groups and/or olefinically unsaturated double bonds.

10. The composite materials according to claim 9 in which at least one at least difunctional and/or difunctionalized low-molecular-weight and/or oligomeric and/or polymeric agent with functional groups and/or olefinically unsaturated double bonds are present as additional materials.

11. The composite materials according to claim 9 in which thermoplastics and/or thermosets and/or elastomers are present as additional materials as matrix materials for glass fibers.

12. The composite materials according to claim 9 in which amino groups, preferably primary and/or secondary amino groups, and/or quaternary ammonium groups are present as functionalities of the adsorbed hydrolysis-stable and/or solvolysis-stable cationic polyelectrolyte complex.

13. A method for producing glass fiber surfaces modified without sizing material and silane, in which method a hydrolysis-stable and/or solvolysis-stable cationic polyelectrolyte and/or a hydrolysis-stable and/or solvolysis-stable cationic polyelectrolyte mixture and/or a hydrolysis-stable and/or solvolysis-stable polyelectrolyte complex with an excess of cationic charges is applied from an aqueous solution at a concentration of maximally 5 wt % to the glass fiber surfaces in an at least partially covering manner during or after the production of glass fibers, wherein hydrolysis-stable and/or solvolysis-stable cationic polyelectrolytes and/or hydrolysis-stable and/or solvolysis-stable cationic polyelectrolyte mixtures with a molecular weight under 50,000 dalton and/or a hydrolysis-stable and/or solvolysis-stable polyelectrolyte complex with an excess of cationic charges are used.

14. The method according to claim 13 in which polyelectrolytes which are not subsequently alkylated and/or acylated and/or sulfamidated after production are used as hydrolysis-stable and/or solvolysis-stable cationic polyelectrolytes, or polyelectrolyte mixtures that are not subsequently alkylated and/or acylated and/or sulfamidated after production are used as hydrolysis-stable and/or solvolysis-stable cationic polyelectrolyte mixtures.

15. The method according to claim 13 in which the following are used as hydrolysis-stable and/or solvolysis-stable unmodified cationic polyelectrolyte, as a pure substance or substances or in a mixture, preferably dissolved in water:
poly(diallyldimethylammonium chloride) (polyDADMAC) and/or copolymers; and/or
polyallylamine and/or copolymers; and/or
polyvinylamine and/or copolymers; and/or
polyvinylpyridine and/or copolymers; and/or
polyethyleneimine (linear and/or branched) and/or copolymers; and/or
chitosan; and/or
poly(amide-amine) and/or copolymers; and/or
cationically modified poly(meth)acrylate(s) and/or copolymers; and/or
cationically modified poly(meth)acrylamide(s) with amino groups, and/or copolymers; and/or
cationically modified maleimide copolymer(s), produced from maleic acid (anhydride) copolymer(s) and, for example, (N,N-dialkylaminoalkylene)amine(s), wherein alternating maleic acid (anhydride) copolymers are preferably used; and/or
cationically modified itaconic imide (co)polymer(s), produced from itaconic acid (anhydride) (co)polymer(s) and, for example, (N,N-dialkylaminoalkylene)amine(s); and/or
cationic starch derivatives and/or cellulose derivatives.

16. The method according to claim 13 in which hydrolysis-stable and/or solvolysis-stable cationic polyelectrolytes and/or hydrolysis-stable and/or solvolysis-stable cationic polyelectrolyte mixtures and/or hydrolysis-stable and/or solvolysis-stable polyelectrolyte complexes with an excess of cationic charges are used at a concentration of maximally 5 wt % in water or in water with the addition of acid, such as carboxylic acid, for example formic acid and/or acetic acid, and/or mineral acid, without additional sizing material or sizing material components and/or silanes.

17. The method according to claim 16 in which hydrolysis-stable and/or solvolysis-stable cationic polyelectrolytes which are not subsequently alkylated and/or acylated and/or sulfamidated after production and/or hydrolysis-stable and/or solvolysis-stable cationic polyelectrolyte mixtures that are not subsequently alkylated and/or acylated and/or sulfamidated after production are used at a concentration of <2 wt %, and particularly preferably at <0.8 wt %.

18. The method according to claim 13 in which hydrolysis-stable and/or solvolysis-stable cationic polyelectrolytes and/or hydrolysis-stable and/or solvolysis-stable cationic polyelectrolyte mixtures with a molecular weight under 50,000 dalton, preferably in the range between 400 and 10,000 dalton, are used.

19. The method according to claim 13 in which a modified hydrolysis-stable and/or solvolysis-stable cationic polyelectrolyte and/or a hydrolysis-stable and/or solvolysis-stable cationic polyelectrolyte mixture that is partially alkylated and/or acylated and/or reacted with carboxylic acid derivatives and/or sulfamidated in a subsequent reaction following production, and is thus equipped with a substituent having reactive and/or activatable groups for a coupling reaction, is then, having the reactive and/or activatable groups of the covalently coupled substituent, reacted with additional materials to form a composite material via at least one functional group and/or via at least one olefinically unsaturated double bond without crosslinking of the hydrolysis-stable and/or solvolysis-stable cationic polyelectrolytes or of the hydrolysis-stable and/or solvolysis-stable cationic polyelectrolyte mixture.

20. The method according to claim 19 in which the partial alkylation of the hydrolysis-stable and/or solvolysis-stable cationic polyelectrolyte or of the hydrolysis-stable and/or solvolysis-stable cationic polyelectrolyte mixture, with substituents having reactive groups thereby being introduced, is achieved through haloalkyl derivatives and/or (epi)halohydrin compounds and/or epoxy compounds and/or compounds which enter into a Michael-analogous addition, advantageously such as acrylates and/or acrylonitrile with amines.

21. The method according to claim 19 in which the partial acylation of the hydrolysis-stable and/or solvolysis-stable cationic polyelectrolyte or of the hydrolysis-stable and/or solvolysis-stable cationic polyelectrolyte mixture, with substituents having reactive groups thereby being introduced, is achieved through carboxylic acids and/or carboxylic acid halides and/or carboxylic acid anhydrides and/or carboxylic acid esters and/or diketenes, or in which a quasi-acylation is achieved through isocyanates and/or urethanes and/or carbodiimides and/or uretdiones and/or allophanates and/or biurets and/or carbonates.

22. The method according to claim 13 in which the hydrolysis-stable and/or solvolysis-stable cationic polyelectrolytes and/or the hydrolysis-stable and/or solvolysis-stable cationic polyelectrolyte mixture and/or the hydrolysis-stable and/or solvolysis-stable polyelectrolyte complexes with an excess of cationic charges are used such that they are dissolved in water, preferably as an ammonium compound, wherein in the case of primary and/or secondary and/or tertiary amino groups carboxylic acid(s) and/or mineral acid(s) are added to the aqueous solution to convert the amino groups into the ammonium form.

23. The method according to claim 13 in which modified glass fiber surfaces that are at least partially, and preferably completely, covered at least with a hydrolysis-stable and/or solvolysis-stable cationic polyelectrolyte or a hydrolysis-stable and/or solvolysis-stable cationic polyelectrolyte mixture and/or a hydrolysis-stable and/or solvolysis-stable polyelectrolyte complex with an excess of cationic or anionic charges are, directly following the production and coating/surface modification thereof and/or at a later point, reacted with additional materials, with chemically covalent bonds thereby being formed.

24. The method according to claim 23 in which the modified glass fiber surfaces are wound and/or intermediately stored as roving and are subsequently reacted with additional materials, with chemically covalent bonds thereby being formed.

25. The method according to claim 23 or 21 in which the hydrolysis-stable and/or solvolysis-stable cationic polyelectrolyte or the hydrolysis-stable and/or solvolysis-stable cationic polyelectrolyte mixture and/or the hydrolysis-stable and/or solvolysis-stable polyelectrolyte complex with an excess of cationic or anionic charges comprises reactive groups in the form of functional groups and/or olefinically unsaturated double bonds that are reacted with functionalities of the additional materials, with chemically covalent bonds thereby being formed.

26. The method according to claim 13 in which an aqueous solution with a concentration of maximally 5 wt % of a hydrolysis-stable and/or solvolysis-stable cationic polyelectrolyte and/or of a hydrolysis-stable and/or solvolysis-stable cationic polyelectrolyte mixture and/or of a hydrolysis-stable and/or solvolysis-stable polyelectrolyte complex with an excess of cationic charges is applied in an at least partially covering manner to commercially produced and sized glass fiber surfaces or to glass fiber surfaces without sizing material and silane, wherein cationic polyelectrolytes or cationic polyelectrolyte mixtures with a molecular weight under 50,000 dalton are used.
